(19) United States
(12) Patent Application Publication
(10) Pub. No.: US 2025/0086086 A1
(43) Pub. Date: Mar. 13, 2025

(54) RESOURCE ALLOCATION USING PROACTIVE RESUME

(71) Applicant: Microsoft Technology Licensing, LLC, Redmond, WA (US)

(72) Inventors: Olga POPPE, Issaquah, WA (US); Qun GUO, Bellevue, WA (US); Willis LANG, Edina, MN (US); Pankaj ARORA, Sammamish, WA (US); Ajay KALHAN, Redmond, WA (US)

(21) Appl. No.: 18/484,853

(22) Filed: Oct. 11, 2023

Related U.S. Application Data
(60) Provisional application No. 63/581,495, filed on Sep. 8, 2023.

(51) Int. Cl. G06F 11/34; G06F 9/50

(52) U.S. Cl. CPC G06F 11/3423; G06F 9/5077; G06F 2209/5011; G06F 2209/5019

(57) ABSTRACT

A proactive resource allocator in a database management system is configured to make database resource allocation decisions for users accessing a database, including proactively resuming resources reclaimed from a user accessing a database. To determine whether to proactively resume resources that are reclaimed from a user who has logged out, the proactive resource allocator accesses historical data to predict a time the user will log back in. If the probability of the user logging back in is high, the proactive resource allocator reallocates resources to the user at the predicted time and may predict a next time the user will log back in. The proactive resource allocator may then logically pause the resources or may physically pause the resources prior to the next predicted time.

### CROSS-REFERENCE TO RELATED APPLICATIONS

This application claims priority to U.S. Provisional Patent Application Ser. No. 63/581,495, filed Sep. 8, 2023, and titled “PROACTIVE RESOURCE RESERVATION,” the entirety of which is incorporated by reference herein.

### BACKGROUND

“Cloud computing” refers to the on-demand availability of computer system resources (e.g., applications, services, processors, storage devices, file systems, and databases) over the Internet and data stored in cloud storage. Servers hosting cloud-based resources may be referred to as “cloud-based servers” (or “cloud servers”). A “cloud computing service” refers to an administrative service (implemented in hardware that executes in software and/or firmware) that manages a set of cloud computing computer system resources.

Cloud computing platforms include quantities of cloud servers, cloud storage, and further cloud computing resources that are managed by a cloud computing service. Cloud computing platforms offer higher efficiency, greater flexibility, lower costs, and better performance for applications and services relative to “on-premises” servers and storage. Accordingly, users are shifting away from locally maintaining applications, services, and data and migrating to cloud computing platforms.

Traditionally, cloud service providers relied on provisioned compute to allocate a fixed amount of resources to users. A newer form of cloud computing is called “serverless compute” (also known as “serverless computing”), which is a cloud computing execution model by which a cloud provider allocates machine resources on demand, taking care of the servers and other compute resources on behalf of their users (e.g., customers). As such, serverless compute eliminates infrastructure management for the user, and allows for dynamic resource scalability and increased functionality speeds. Serverless compute also provides backend services to users without the added task of developing and managing an infrastructure.

Serverless cloud computing services, such as relational database service providers deploy automatic, fully managed databases to guarantee high Quality of Service (“QoS”) to users, while controlling Cost of Goods Sold (“COGS”). Existing resource scaling policies of database service providers tend to be reactive to the real-time activity of users. For instance, reactive policies tend to allocate and scale resources to customers in response to the active, ongoing needs of customers. A reactive approach to resource allocation works in real-time to make decisions on how to allocate and scale resources based on user demands.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A proactive resource allocator in a database management system is configured to make database resource allocation decisions for users accessing a database, including proactively resuming resources reclaimed from a user accessing a database. To determine whether to proactively resume resources that are reclaimed from a user who has logged out, the proactive resource allocator accesses historical data to predict a next time the user will log back in. If the predicted next time of user login is relatively soon, the proactive resource allocator reallocates the resources to the user. If the predicted next time of user login is relatively far away, the proactive resource allocator keeps (maintains) the resources reclaimed.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a timeline representation of reactive resume, according to an example embodiment.

FIG. 2 shows a timeline representation of inefficient pause, according to an example embodiment.

FIG. 3 shows a block diagram of a database management system for query execution that enables scaling for allocating and reclaiming database resources, in accordance with an embodiment.

FIG. 4 shows a block diagram of a proactive resource allocator configured to make decisions on allocating and reclaiming database resources, in accordance with an embodiment.

FIG. 5 shows a block diagram of a server set backend for processing data from a resource allocator, in accordance with an embodiment.

FIG. 6 shows a state diagram for proactive resume and proactive pause, in accordance with an embodiment.

FIG. 7 shows a flowchart of a process for proactive resume, in accordance with an embodiment.

FIG. 8A shows a timeline representation of a sliding window algorithm for historical user activity of a database, in accordance with an embodiment.

FIG. 8B shows a further timeline representation of a sliding window algorithm for historical user activity of a database, in accordance with an embodiment.

FIG. 9 shows a timeline representation of proactive resume, according to an example embodiment.

FIG. 10 shows a flowchart of a process for calculating a login probability for a time window, in accordance with an embodiment.

FIG. 11 shows a flowchart of a process for determining a time period for maintaining reallocation of resources, in accordance with an embodiment.

FIGS. 12A and 12B show flowcharts of processes related to pausing resources with respect to a next predicted start of activity, in accordance with embodiments.

FIG. 13 shows a flowchart of a process for utilizing a sliding window algorithm in a proactive resume process, in accordance with an embodiment.

FIG. 14 shows a flowchart of a process for stepping through time windows to find user activity, in accordance with an embodiment.

FIG. 15A shows a flowchart of a process for handling allocated resources when sufficient user activity to warrant resuming allocated resources is not found in the historical data, in accordance with an embodiment.

FIG. 15B shows a flowchart of a process for utilizing a machine learning model, in accordance with an embodiment.

FIG. 16 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

### A. Example Resource Scaling Implementations

A prevalent form of cloud computing platforms is serverless computing, which eliminates infrastructure management, allowing for further dynamic resource scalability and increased functionality speeds. Resource “scaling” refers to allocating and/or deallocating resources to and from a user, based on the needs of the user. Serverless computing provides backend services to users without the added task of developing and managing an infrastructure.

A database is an organized collection of data, generally stored and accessed electronically from a computer system. Users at computing devices may read data from a database, as well as write data to the database and modify data in the database through the use of queries. Queries are formal statements of information needs, such as a search string applied to a table in a database. A database management system (DBMS) includes program code that interacts with end users, applications, and the database itself to capture and analyze the data. The DBMS additionally encompasses the core facilities provided to administer the database. The sum total of the database, the DBMS and the associated applications may be referred to as a “database system”. The term “database” is also often used to loosely refer to any of the DBMS, the database system or an application associated with the database.

SQL (structured query language) is a domain-specific language used in programming and designed for managing data held in a relational database management system (RDBMS), or for stream processing in a relational data stream management system (RDSMS). SQL is particularly useful in handling structured data, which is data incorporating relations among entities and variables.

Serverless cloud computing services, such as relational database service providers, frequently deploy automatic, fully managed databases to provide high Quality of Service (“QoS”) to users, while controlling Cost of Goods Sold (“COGS”). Existing resource scaling policies in database service providers, however, tend to be merely reactive and not suitable for time-critical applications. In other words, resource allocation and scaling occur in response to the active, ongoing needs of customers. A reactive approach to resource allocation works in real-time to make decisions on how to allocate and scale resources based on user demands. Resources can be either “paused,” “resumed,” or “reclaimed” for allocations. When paused, allocated resources are maintained as available to a user, despite possibly going unused by the user. When resumed, resources are allocated to a user. When reclaimed, resources are taken back by a database service provider and possibly assigned for use elsewhere. There is no limit to the number of pauses, resumes, and reclamations for a database to initiate. Typically, for reactive scaling policies, resources are resumed when users log into a database and resources are reclaimed when users log out of a database.

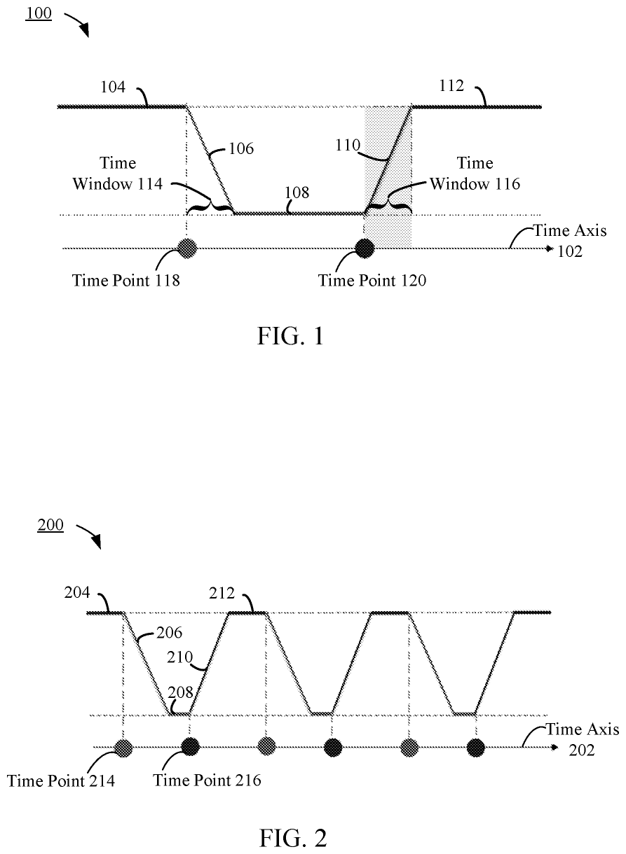

A reactive scaling policy sets a reactive resume approach for resource allocation of a user logging in and out of a database, which can be inefficient. For instance, FIG. 1 shows a timeline 100 representation of reactive resume according to a reactive scaling policy. Timeline 100 comprises a time axis 102. A sequence of time segments is plotted against time axis 102 that includes a first time segment 104, a second time segment 106, a third time segment 108, a fourth time segment 110, and a fifth time segment 112, which as further described below, represent time periods during which the user does or does not have access to a database. Furthermore, a first time window 114 and a second time window 116 are shown represented, and a first time point 118 and a second time point 120 are plotted with respect to time axis 102. Timeline 100 is described as follows.

Timeline 100 begins with earliest time segment 104, during which the user is logged into the database, and the database is “resumed” for the user, where “resumed” means that resources (e.g., compute nodes, storage, etc.) are allocated to and useable by the user. During a “resumed” time period, the user may be charged (pay money) for access to the resources.

At time point 118 (at the end of first time segment 104), the user logs out of the database. Thus, during subsequent time segment 106, the database is “paused,” where “paused” means that the user is not able to access the resources, and the resources may be reclaimed from the user. Note that there are two types of “paused” states. “Logically paused” or “logical pause” means the resources are still allocated to the user, but the user is not using them because the user is logged out of the database. When logically paused, the user is not charged for the resources, even though the resources are allocated to the user and cannot be allocated elsewhere to support other users (which is inefficient use of the resources). “Physically paused” or “physical pause” means the resources are no longer allocated to the user (the resources have been reclaimed). When physically paused, the user is no longer charged for the resources. During time segment 106, the resources are physically paused, such that they will no longer be allocated to the user. The downslope of time segment 106 represents the amount of time it takes to downscale/reclaim the resources (e.g., to a resource pool), which is a non-zero amount of time, and can be significant (e.g., in the order of minutes or more). Thus, time segment 106 represents a delay between time segment 104, during which resources are allocated to the user, and time segment 108 (following time segment 106), during which resource are fully reclaimed from the user.

At time point 120 (at the end of time segment 108), the user logs back into the database (i.e., to continue work) and during time segment 112, the database is resumed and resources are reallocated to the user. Note that the upslope of time segment 110 represents the amount of time it takes to upscale/reallocate the resources (e.g., from a resource pool), which is a non-zero amount of time, and can be significant (e.g., in the order of minutes or more). Thus, time segment 110 represents the delay between time segment 108, during which resources are paused (reclaimed) and the user has no access to them, and time segment 112 (following time segment 110), during which resources are reallocated to the user and fully resumed. As such, the database may auto-scale resources to and from the user based on the user logging in and out of the database, respectively. The database may require time window 114 (covering time segment 106) to fully pause the database and reclaim resources and may require time window 116 (covering time segment 110) to fully resume the database and reallocate resources. During time window 116, it is noted that resources are unavailable to the user due to the process of resuming resources. The lengths of time windows 114 and 116 and their non-zero durations are related to the performance of the database, the workload of the database, the number of users accessing the database, database lags, the speed of various functions of the database, or any other factor affecting the time in which it takes the database to auto-scale resources.

Thus, FIG. 1 represents an inefficient reactive resume approach to handling a logout of the user followed by a log back in. A great deal of access time to the resources is wasted due to the non-zero reclaiming and reallocation times. Furthermore, frequent scaling operations increase the infrastructure load, potentially resulting in performance and/or reliability issues.

Reactive scaling policies may also result in inefficient resource allocation of a user who repeatedly logs in and out of a database. For instance, FIG. 2 shows a timeline 200 representation of such an inefficient pause, according to an example embodiment. Timeline 200 comprises a time axis 202. A sequence of time segments is plotted against time axis 202 that includes a first time segment 204, a second time segment 206, a third time segment 208, a fourth time segment 210, and a fifth time segment 212, which as further described below, represent time periods during which the user does or does not have access to a database. Furthermore, time points are indicated on time axis 102, including a first time point 214 and a second time point 216. Timeline 200 is further described as follows.

Timeline 200 begins at an earliest time segment 204, during which the user is logged into the database and resources are allocated to the user (resumed). At time point 214 (at the end of time segment 204), the user logs out of the database. Thus, during subsequent time segment 206, the database is physically paused, and resources are reclaimed from the user. The downslope of time segment 206 represents the amount of time it takes to down-scale/reclaim the resources (e.g., to a resource pool), which as described above can be a significant amount of time, during which the resources are unusable to anyone. Thus, time segment 206 represents the delay between time segment 204, during which resources are allocated to the user, and time segment 208 (following time segment 206), during which resources are reclaimed and not available to the user (and potentially allocated elsewhere). At time point 216 (at the end of time segment 208), the user relogs into the database and during subsequent time segment 210, the database gradually resumes, and thus gradually reallocates resources to the user. The upslope of time segment 210 represents the amount of time it takes to upscale/reallocate the resources, and thus time segment 210 represents the delay between time segment 208, during which resources are not allocated to the user, and time segment 212 (following time segment 210), during which resources are gradually made available to the user. The pattern of logging out and in by the user is shown repeating in FIG. 2, and the corresponding repeated gradual reallocating and reclaiming of resources leads to significant lost time during which the resources could be allocated elsewhere (during the down-sloping segments when the user just logged out), as well as lost access time by the user to the resources (during the upsloping segments when the user just logged back in). Thus, FIG. 2 represents an inefficient reactive pause approach to handling the repeated login and logout interactions of the user. A great deal of access time to the resources is wasted due to the repeated non-zero reclaiming and reallocation times. Furthermore, frequent scaling operations increase the infrastructure load, potentially resulting in performance and/or reliability issues.

In general, in reactive scaling policies, resource usage patterns of the prior activity of each customer are not taken into account and resource allocation is not instantaneous. As a result, resource delays occur unexpectedly for customers, thus lowering QoS, and resources are wasted for providers, thus increasing COGS. There is a need for efficiently allocating and scaling resources to users for execution of complicated analytical queries and processing massive amounts of data.

The negative impact on QoS and COGS of the reactive policy is amplified by the complexity of elastic pools. Elastic pools are pools of available resources shared by multiple databases from which users may purchase resources to accommodate unpredictable periods of usage by individual databases. In one example, an elastic pool may contain up to 500 databases. Each of these databases can have a unique resource usage pattern. All databases in a pool can be activated at the same time, causing an activation storm with high resource demand and tight latency requirements. High QoS can be achieved by provisioning resources to elastic pools. However, doing so may result in low utilization of resources and wasted COGS.

Auto-scaling resources for elastic pools in a database management system may be based on current workload demand. As long as the database is active, resources are resumed for the database. Once the database becomes idle, the resources are logically paused. Resources are still available during logical pauses but the corresponding customers are not billed. In this way, overhead of frequent scaling is avoided due to short idle intervals in which the customer is not actively requiring resources. If after an amount of time, for instance, 7 hours of logical pause, the database is still idle, resources are physically paused (i.e., reclaimed) to save COGS.

One limitation of the aforementioned database provider example is that scaling mechanisms are not instantaneous. In an example implementation, resuming the resources for a database takes 40 seconds on average and there is no guaranteed upper bound. Therefore, resources are not immediately available when a customer comes back online after a prolonged idle period during which the resources are reclaimed. A few seconds of delay may not be acceptable for latency-sensitive cloud services.

A second limitation of the aforementioned database provider example is that half of idle intervals are longer than the current duration of logical pause. Resources can be effectively reused by other databases and COGS can be saved during such extensive idle intervals. Currently, these idle intervals are shortened by logical pause.

In embodiments, proactive scaling is performed by methods, systems, and apparatuses in ways that overcome the limitations of conventional techniques. In particular, the reactive nature of current serverless compute solutions is overcome by proactive resource scaling policies. Proactive scaling policies enable resource scaling according to known, calculable, or predictable compute needs of a user. Rather than wait for the user to log in or log out of a database, proactive scaling can pause (i.e., “proactively pause”, also referred to as “proactive pause,” or “predictive pause”) and resume (i.e., “proactively resume”, also referred to as a “proactive resume” or “predictive resume”) resources in anticipation of activity from the user, or a lack thereof. For example, a database may resume resources ahead of time, based on a calculation that a user will soon log into a database. When the user actually logs into the database, the user does not have to wait for the resources because they are already resumed, improving QoS for the user without charging the user for proactively scaling their resources. In an alternative example, resources may be reclaimed by the database provider when the user, now logged out of the database, is predicted to remain logged out for a period of time, saving the provider resources and COGS.

In an embodiment, proactive scaling may be developed from user patterns and user history with a database, data of which is gathered by monitoring user activity and then processing or analyzing the data. Data may be gathered over a specified period of time and updated regularly as the user continues to use a database and accumulate new data for the provider to learn from. Leveraging historical traces to detect typical resource usage patterns per database can overcome the limitations of reactive policies for singleton databases. To guarantee high QoS, resources of a physically paused database are proactively resumed if the next predicted time is soon, (e.g., within a few minutes). To save COGS, the resources of an idle database are physically paused if the next predicted resume time is far (e.g., later than 7 hours). In this way, the logical pause is avoided for predicted long idle intervals. To relieve the backend from the overhead of frequent scaling operations, the resources of an idle database are logically paused if the next predicted time is either unknown or soon (e.g., within 7 hours).

Analogously to singleton databases, historical traces to detect activation storms may be leveraged in elastic pools as well. Resources may be proactively reserved some time (e.g., a few minutes) ahead of a predicted activation storm and proactively reclaimed if no activation storm is predicted in the near future (e.g., within a few minutes). In this way, there is a middle ground, or balance, between opposing optimization objectives of high QoS, low COGS, and low overhead and between the contradictory goals of enabling proactive resume, while reducing the number of short pauses.

Indeed, increasing the number of resumes increases the number of wrong resumes (i.e., the customer did not come online as expected). Wrong resumes in turn increase the number of pauses, some of which tend to be short. Also, reducing the number of short pauses reduces the number of resumes, making the task of correct resume harder because of fewer historical resumes. Herein, in embodiments, solutions to this serverless compute problem are provided. Such embodiments may be implemented in a variety of ways to provide their functionality and advantages. In the following subsections, these and further embodiments are described in detail. In particular, the next subsection describes example proactive resource allocation implementations, followed by a subsection that describes embodiments for proactive resume.

### B. Example Embodiments for Proactive Resource Allocation

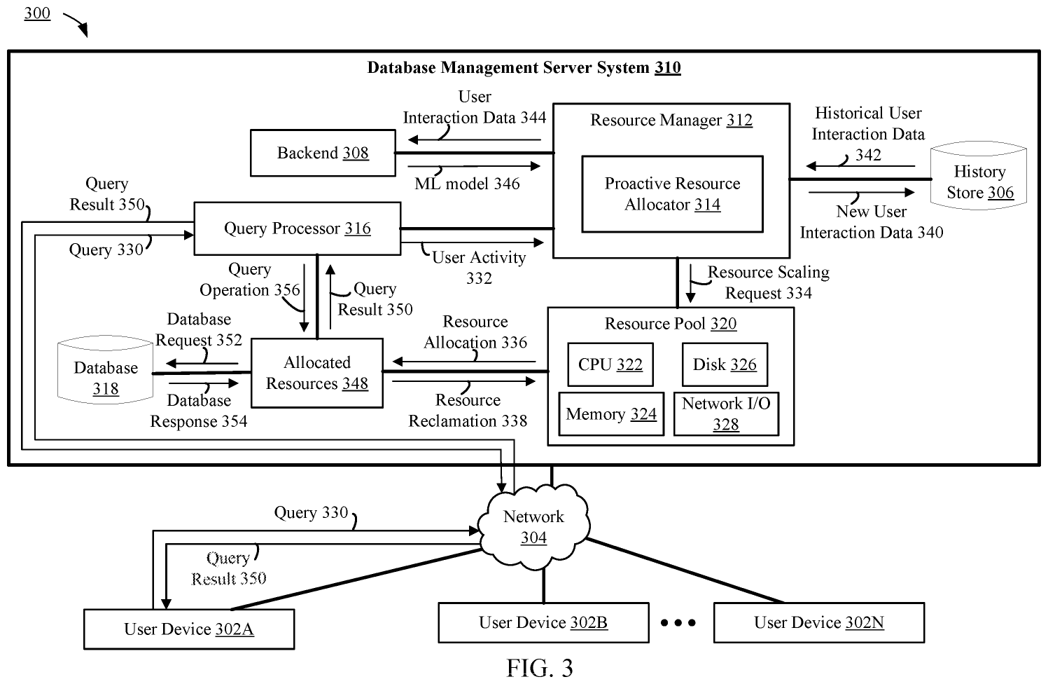

For instance, FIG. 3 shows a block diagram of a query servicing system 300, in an embodiment, that includes a database management server system 310 and user devices 302A-302N. A network 304 communicatively couples database management server system 310 and user devices 302A-302N. Database management server system 310 includes a history store 306, a backend 308, a resource manager 312, a query processor 316, a database 318, a resource pool 320, and allocated resources 348. Resource manager 312 includes a proactive resource allocator 314. Resource pool 320 may include any quantities of resources and resource types, such as a CPU 322, memory 324, disk 326, and network I/O 328, each of which may be present in any quantity and number of different types. Database management server system 310 is configured to manage access by users to database 318. Users of user devices 302A-302N may interact with system 310 to access data of database 318. These components of system 300 are described in further detail as follows.

Query processor 316 (e.g., an SQL engine in an SQL server) is configured to execute query logic on behalf of users that are logged into a database serviced by query processor 316. Query processor 316 tracks the users that are logged into a database from a user device, such as one of user devices 302A-302N, as well as the users that are logged out. For the users that are logged in, query processor 316 processes queries (received from their user devices) that are configured to manipulate data (e.g., add, change, delete data) of database 318 and generate a query result. For example, as shown in FIG. 3, query processor 316 receives a query 330 over network 304 submitted by a user at user device 302A. Query processor 316 processes query 330 by determining one or more query operations 356, which are individual query operations for execution on data of database 318. Query processor 316 transmits query operation(s) 356 to allocated resource 348 for execution. As further described elsewhere herein, allocated resources 348 includes resources allocated to the user for executing queries. Allocated resources 348 executes query operation(s) 356 to generate a query result 350 that is transmitted to query processor 316 for return to the user in response to query 330.

As mentioned above, allocated resources 348 includes resources allocated for query processing for the user. Allocated resources 348 are allocated from resource pool 320, which is a pool of computing resources. Examples of resource types in resource pool 320 (which may be allocated in allocated resources 348) include compute resources (e.g., CPU 322), storage (e.g., disk 326), memory (e.g., memory 324), network input/output (I/O, e.g., network I/O 328), and/or any other resource required for accessing a database. Such resources may be present in resource pool 320 in any suitable quantity.

Resource manager 312 is configured to manage resource allocation within database management server system 310, including the allocation of resources from resource pool 320 to allocated resources 348 for use by the user. For example, query processor 332 may transmit user activity 332 to resource manager 312. When received, user activity 332 indicates to resource manager 312 that the user is actively utilizing allocated resources 348 allocated to the user. User activity 332 may include further information as well, including a number and type of operations included in query 330 and/or further queries of the user, based on which resource manager 312 may scale resources in allocated resources 348 to adequately support the user queries. In particular, resource manager 312 may transmit resource scaling request 334, indicating a request to scale resources, to resource pool 320, which causes resources of resource pool 320 to be allocated to the user as allocated resources 348.

Note that although allocated resources 348 are shown in FIG. 3 as external to resource pool 320, resources do not physically move when allocated to allocated resources 348 from resource pool 320 or are reclaimed from allocated resources 348 back to resource pool 320. The allocation of allocated resources 348 is a logical allocation. Allocated resources 348 maintain the same physical position from which they are allocated.

As shown in FIG. 3, resource manager 312 includes proactive resource allocator 314, which enables resource manager 312 to allocate resources to the user in a proactive manner according to embodiments. Proactive resource allocator 314 retrieves historical user interaction data 342 from history store 306, which stores past (historical) data indicative of interactions (e.g., user queries) by the user with database 318. Proactive resource allocator 314 uses historical user interaction data 342 to make proactive resource scaling decisions based on historical user interactions of the user with database 318. Proactive resource allocator 314 may also store new user interaction data in history store 306 by transmitting new user interaction data 340 to history store 306. History store 306 may comprise information on historical user interactions of the user with database 318 going back any desired amount of time, including interactions in the previous minutes, hours, days, weeks, months, and/or years.

It is noted that proactive resource allocator 314 may determine when user interaction data becomes too old to be stored any longer, in which case proactive resource allocator 314 may instruct history store 306 to store the old data in long time (e.g., offline storage) in backend 308.

Backend 308, in embodiments, may be configured to perform training, calibrating, and/or updating of one or more machine learning (ML) that may be provided to proactive resource allocator 314 as trained ML model 346. Proactive resource allocator 314 may use ML model 346 to perform proactive resource allocation as further described elsewhere herein.

As described above, resource pool 320 may receive resource scaling request 334 from resource manager 312. Responsive to request 334, resources of resource pool 320 may be allocated to or reclaimed from allocated resources 348. For instance, a resource allocation indication 336 may allocate resources to allocated resources 348 for query processor 316 to use to service queries issued to the user. Resource reclamation 338 causes allocated resources to be reclaimed from allocated resources 348 as no longer required to service user queries. Allocated resources 348 may interact with database 318, such as by sending data requests associated with query operations, by transmitting database request 352 to database 318. In response, database 318 may transmit database response 354 to allocated resources 348 with the requested data. When the operations of query 330 have been executed in allocated resources 348, query result 350 is generated and returned by query processor 316 (or directly from allocated resources 348) over network 304 to the user at user device 302A.

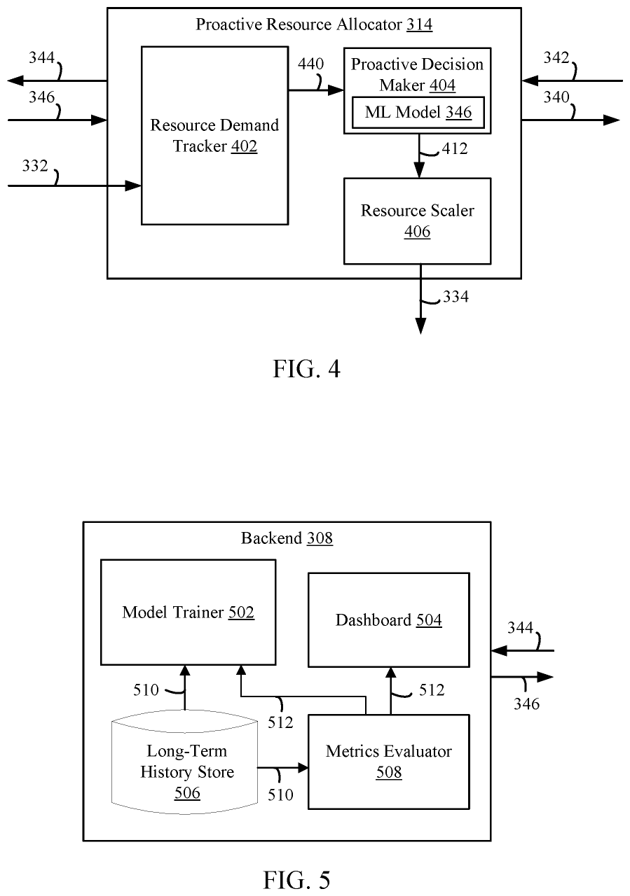

Proactive resource allocator 314 of FIG. 3 may be implemented in various ways to perform the functions described above and further functions. For instance, FIG. 4 shows an example implementation of proactive resource allocator 314, according to an embodiment. As shown in FIG. 4, proactive resource allocator 314 includes a resource demand tracker 402, a proactive decision maker 404, and a resource scaler 406. These components of proactive resource allocator 314 are further described as follows.

Resource demand tracker 402 of proactive resource allocator 314 is configured to monitor and/or track user activity and user interactions with database 318, as received in user activity 332. New user interaction data 340 may be generated by resource demand tracker 402 based on user activity 332 and transmitted to history store 306 for storage. Resource demand tracker 402 may further send user activity data as tracker data 440 to proactive decision maker 404.

Proactive decision maker 404 is configured to analyze information of tracker data 440 and historical user interaction data 342 to detect when a user logs in, logs out, and/or becomes idle, and to determine a resource allocation response (i.e., to allocate or reclaim resources), which is provided in a scaling decision 412. Proactive decision maker 404 is configured to generate scaling decision 412 in a proactive manner, such that resources are scaled proactively, as described herein, rather than reactively. For instance, if proactive decision maker 404 determines a user has become idle due to no query activity received in a predetermined amount of time or has logged out of an account used to generate queries to database 318, proactive decision maker 404 may generate scaling decision 412 to proactively logically pause the user or to proactively physically pause the user (reclaim resources of the user). Proactive decision maker 404 may also predict that a user will soon log into an account used to generate queries to database 318, and in response, may generate scaling decision 412 to proactively allocate resources to the user. Proactive decision maker 404 may be configured or optimized according to ML model 346, in embodiments, to proactively scale resources, as further described elsewhere herein.

Resource scaler 406 receives scaling decision 412. Resource scaler 406 is an interface with resource pool 334 that is configured to perform resource scaling according to scaling decision 412. In particular, resource scaler 406 is configured to generate a resource scaling request 334 that is transmitted to resource pool 320. Resource scaling request 334 causes resource pool 320 to allocate resources to, or reclaim resources from, allocated resources 348.

Further to the example implementation of proactive resource allocator 314 of FIG. 4, backend 308 of FIG. 3 may be implemented in various ways. For instance, FIG. 5 shows an example implementation of backend 308 according to an embodiment, As shown in FIG. 5, backend 308 includes a model trainer 502, a dashboard 504, a long-term history store 506, and a metrics evaluator 508. These features of backend 308 are further described as follows.

Long-term history store 506 comprises long-term storage of user activity and interactions with database 318 and receives user interaction data in user interaction data 344 from proactive resource allocator 314. Long-term history store 506 proves useful for accessing more historical data about a user, particularly when accuracy worsens for proactive decision maker 404.

Model trainer 502 is configured to train and tune (modify) parameters of ML model 346 (when present) of proactive decision maker 404. Such parameters configure proactive decision maker 404 to make optimized decisions while balancing QoS and COGS within database system 300. Model trainer 502 may read historical user interaction data from long-term history store 506 as long-term user interaction data 510. For instance, model trainer 502 may train ML model 346 using feature values extracted from long-term history store 506 and/or history store 306 by long-term user interaction data 510, including user login times, user log out times, user idle times or periods, user query submission times, numbers of queries submitted by the user, and/or any other suitable parameters related to user activity and inactivity related to database 318. The machine learning training algorithm used by model trainer 502 may be supervised or unsupervised. Model trainer 502 may be configured to train and generate trained ML model 346 according to any suitable type of machine learning model, including a CNN (convolutional neural network) using 1D or other dimension of convolution layers, a long short-term memory (LSTM) network, one or more transformers, a gradient boosting decision tree model, a regularized regression model, a random forest model, or any other suitable type of ML model.

Metrics evaluator 508 receives long-term user interaction data 510 from long-term history store 506 and is configured to extract and evaluate metrics including key performance indicators (i.e., KPIs). Metrics to be determined by metrics evaluator 508 may be configured by a provider of database management server system 310, in an embodiment. Example of such metrics may include a percentage of user logins that occurred during a time interval in which resources were already allocated, in addition to a database provider's cost of maintaining the aforementioned allocated resources. In an embodiment, model trainer 502 and metrics evaluator 508 may each specify a respective length of time of historical data to read in long-term user interaction data 510 for their respective purposes. It is noted that, in embodiments, metrics evaluator 508 may evaluate one or more of the following to determine key performance indicators: calculating a percentage of user logins by the user while the resources are allocated to the user, calculating a percentage of user logins by the user while the resources are reclaimed from the user, calculating a percentage of time that the resources are in use by the user, calculating a percentage of time that the resources are allocated to the user but are not in use by the user, and/or calculating a percentage of time that the resources are reclaimed from the user.

Dashboard 504 may represent a dashboard for visualizing metrics data (e.g., metrics data 512 from metrics evaluator 508). Dashboard 504 may be accessible by a provider of database management server system 310 for reviewing the performance and/or success of proactive resource allocator 314, in an embodiment. Dashboard 504 may present such metrics data in a user interface, such as a graphical user interface (GUI), for review and analysis by users.

Proactive decision maker 404 may be configured in various ways to use user interaction data to proactively scale resources for the user, including through the use of ML model 346, by a proactive scaling algorithm, and in further ways. Resume patterns may be established from user interaction data stored for a user. A resume pattern is a pattern of allocation and reclamation of resources for a user based on a pattern of log ins, log outs, idle times, etc. of the user. In an embodiment, resume patterns of a user related to a database may be analyzed over time by proactive decision maker 404, based on information from historical user interaction data 342, extracted from history store 306. Resume patterns assist proactive decision maker 404 in making scaling decision 412 to proactively resume and/or proactively pause a database. For example, an analysis by proactive decision maker 404 for a particular database may reveal that database 318 is typically resumed for a user between 5:40 AM and 9:20 AM on Wednesdays. Based thereon, proactive decision maker 404 may determine a user probability of resuming usage of the database. In an embodiment, for proactive decision maker 404 to determine the probability of resume (i.e., how likely a user will log in during the aforementioned time window and require resources), the following calculation may be included. Let H(s) be the historical data of a database s, let h(s, d) be the number of weekdays d in H(s), and let r(s, d, w) be the number of d's on which s was resumed during a window w in H(s). Thus, the probability of resume of s on d during w may be computed by proactive decision maker 404 as, per Equation (1):

$$p ( s , d , w ) = \frac{r ( s , d , w )}{h ( s , d )} \qquad ( 1 )$$

Model trainer 502 may be configured with, or configured to determine, a threshold θ, indicative of when a probability is high, and communicate the threshold to proactive decision maker 404 via training of ML model 346. Thus, in an embodiment, proactive decision maker 404 may make a probabilistic resume recommendation (i.e., scaling decision 412) to proactively resume a database s on a weekday d at the beginning of a window w if, per Equation (2):

$$p ( s , d , w ) \geq θ \qquad ( 2 )$$

A probabilistic resume recommendation may be determined by proactive decision maker 404 using resume recommendations R on a weekday d based on historical data of databases S comprising a set of time windows W within a day. For each database s E S and each window w E W, Algorithm 1, as follows, may be configured for proactive decision maker 404 to add a recommendation [s, d, w] to proactively resume a database s on a weekday d at the beginning of a window w to the set of results R if the probability of resume p(s, d, w) satisfies the threshold θ.

Algorithm 1: Probabilistic Proactive Resume

```
  Input: Historical data of databases S, set of windows W within one day,
probability threshold θ
  Output: Set of resume recommendations R on a weekday d
```

| | |
|---|---|
| 1: | for each s ∈ S do |
| 2: | for each w ∈ W do |
| 3: | if p(s, d, w) ≥ θ then R ← R ∪ [s, d, w] |
| 4: | return R |

In addition to probabilistic resume recommendations, predictive resume recommendations (i.e., scaling decision 412) may be determined by proactive decision maker 404 for a user, in an embodiment. A predictive resume algorithm may be analogous to Algorithm 1 above and implemented in proactive decision maker 404, except that a predictive resume algorithm consumes historical predicted pause and resume patterns from proactive decision maker 404, which may be stored in history store 306, and may indicate whether the historical predictions were correct or incorrect. Given the predicted pause and resume pattern P(s, d, w) for a database s on a weekday d during a window w, the predictive resume recommendation of Algorithm 1 by proactive decision maker 404 may be to proactively resume s on d at the beginning of w if ∃resume∈P(s, d, w).

It is noted that any machine learning (e.g., ML) model, such as NimbusML, can be applied to Algorithm 1 in proactive decision maker 404 as ML model 346 to predict pause and resume patterns using database and user history. A machine learning model may represent an algorithm learned by a machine. The ML model may be trained based on user log in and log out histories as input features. For instance, model trainer 502 of FIG. 5 may be used to train ML model 346, as further described elsewhere herein.

Given historical data H(s) of a database s and a threshold θ, s is called stable if s is either resumed or paused at least θ% of the time in H(s). Otherwise, s is unstable. In an embodiment, a pattern may be determined by the following: Let s be an unstable database, H(s) be the historical data of s, d be a weekday, w be a window, and θ be a threshold. s follows a pattern if at least θ% of its resumes and pauses happen within the window w on each weekday d in H(s). A database s is called predicable if s is stable or follows a pattern. Otherwise, s is called unpredictable.

Although proactive resumes improve QoS, they may also shorten pauses during which resources could be reused and COGS could be saved, in an embodiment.

Furthermore, some proactive resumes may be incorrect, wasting COGS due to incorrectly timed resumes. The operational cost of proactive resume can be defined by a resume cost index, the ratio of the wasted cost to the total cost savings, and implemented as a metric in metrics evaluator 508. Let pauses(s) be the total duration of all pauses of a database s in hours without proactive resume, let vcores(s) be the maximum vCores (i.e., “virtual core” representing a logical CPU) of s, let cost be COGS per vCore per hour in dollars, and let wait(s) be the total wait time in hours until proactively resumed resources of s are used. The cost index depends on several tunable parameters, such as the size of the window and the length of historical data. Such parameters may be tuned by model trainer 502. The total cost savings and wasted cost is calculated as follows in Equation (3) and Equation (4):

$$Total cost savings = {\sum }_{s ∈ S} pauses ( s ) \times vcores ( s ) \times cost \qquad ( 3 )$$

$$Wasted cost = {\sum }_{s ∈ S} wait ( s ) \times vcores ( s ) \times cost \qquad ( 4 )$$

A middle ground, or balance, in which both QoS and COGS are optimized by model trainer 502 tuning the parameters of proactive decision maker 404, may be determined while enabling proactive resume. In an embodiment, the percentage of databases per their lifetime in weeks may be measured by model trainer 502. Sufficient user data (i.e., long-term user interaction data 510) over a time span (e.g., 3 weeks at least for a long-lived database, less than 3 weeks for a short-lived database) is received from long-term history store 506 by model trainer 502 and metrics evaluator 508. To determine the middle ground, a time window size is varied by metrics evaluator 508 on long-term user interaction data 510 to measure various metrics such as: a percentage of correct and incorrect proactive resumes among all resumes in the window, a percentage of databases that have correct proactive resumes in the window, and a resume cost index in the window (i.e., metrics data 512). The cost index is low for shorter windows. Unfortunately, the cost index may also grow with an increased window size, since proactively resumed resources remain idle longer. Metrics data 512 is sent to dashboard 504 for visualizing or to model trainer 502 for further analysis to balance QoS and COGS by tuning model parameters. A length of historical data (e.g., number of weeks) may also be varied by model trainer 502 and metrics evaluator 508 to determine the middle ground more effectively. Based on database trials and analyses, most resumes are proactive and correct within a few hours for long-lived databases and most long-lived databases benefit from QoS and COGS optimization.

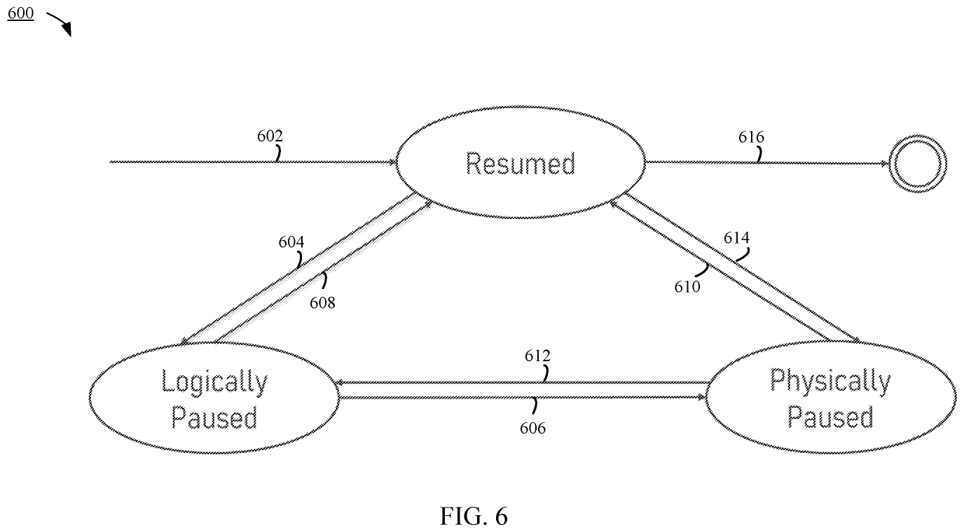

In an embodiment, a state diagram may be used to represent transitions between resumed and paused states. For instance, FIG. 6 shows a state diagram implementation of FIG. 3, FIG. 4, and FIG. 5 collectively as state diagram 600, according to an embodiment. State diagram 600 includes a Resumed State, a Logically Paused State, and a Physically Paused state. State diagram 600 further includes a transition 602, a transition 604, a transition 606, a transition 608, a transition 610, a transition 612, a transition 614, and a transition 616. The Resumed State denotes a resumed database in which resources are allocated to a user, the Logically Paused State denotes a paused database in which the user is allocated resources but is not billed for them due to lack of use, and the Physically Paused State denotes a paused database in which resources have been reclaimed from the user. State diagram 600 is further described as follows with reference to FIGS. 3-5.

State diagram 600 begins at transition 602, in which a query 330 is created due to activity from user device 302A and provided to query processor 316. Allocated resources 348 initiate at the Resumed State for query processor 316 to execute further queries for the user. At transition 604, the user is determined idle by resource demand tracker 402 in user activity 332, from query processor 316.

Further at transition 604, the next predicted resume time of the user is determined by proactive decision maker 404 as either soon or unknown (e.g., by Algorithm 1). As a result, proactive decision maker 404 makes scaling decision 412 to logically pause allocated resources 348, which transitions from the Resumed State to the Logically Paused State.

At transition 606, resource demand tracker 402 continues to determine the user as idle and the Logically Paused State has reached a threshold parameter. The threshold parameter may represent a value, such as a maximum wait time, determined in proactive decision maker 404 by model trainer 502 in training of ML model 346. Further at transition 606, the next predicted resume time, according to proactive decision maker 404 (e.g., Algorithm 1), is far. Thus, proactive decision maker 404 makes scaling decision 412 to physically pause allocated resources 348, which transitions from the Logically Paused State to the Physically Paused State.

At transition 612, if the user remains idle while allocated resources 348 are in the Physically Paused State, but the next predicted resume time according to proactive decision maker 404 is soon, scaling decision 412 may logically pause allocated resources 348, which transition from the Physically Paused State to the Logically Paused State.

However, at transition 608 or transition 610, if the user is determined as active by resource demand tracker 402, allocated resources 348 may transition from either the Logically Paused State or the Physically Paused State to the Resumed State by scaling decision 412.

At transition 614, the user is determined as idle by resource demand tracker 402, allocated resources 348 are in the Resumed State, and proactive decision maker 404 may predict the next resume time is far. In this case, allocated resources 348 transition from the Resumed State to the Physically Paused State.

At transition 616, while allocated resources 348 are in the Resumed State, the user is determined to have logged out of the database by resource demand tracker 402, which notifies proactive resource allocator 314. Proactive resource allocator 314 predicts that the user will be logged out for a long time and decides to drop (e.g., reclaim and release) allocated resources 348 from the user for use elsewhere in database management server system 310.

### C. Further Example Embodiments for Proactive Resume

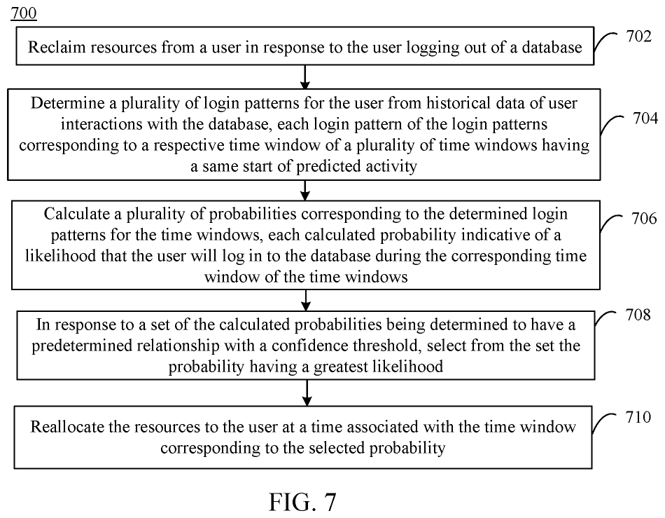

As described above, proactive resource allocator 314 may perform proactive resume, where resources are proactively resumed (allocated) for a user based on predicted future use. Proactive resource allocator 314 may be structured and may operate in various ways to perform such functions. For instance, Flowchart 700 in FIG. 7 shows a process for proactive resume according to an embodiment. Flowchart 700 may be performed by proactive resource allocator 314 of FIGS. 3 and 4. In some embodiments, not all steps of flowchart 700 need be performed. Other structural and operational embodiments will be apparent to persons skilled in the relevant art(s) based on the following discussion regarding flowchart 700, which is provided with reference to FIGS. 3-5 for purposes of illustration.

Flowchart 700 of FIG. 7 begins with step 702. In step 702, resources are reclaimed from a user in response to the user logging out of a database. In an example, proactive resource allocator 314 may reclaim resources (e.g., allocated resources 348) from a user in response to the user logging out of a database, such as database 318. Resource demand tracker 402 in FIG. 4 may determine that the user logged out based on user activity with respect to query processor 316. For instance, query processor 316 may provide indications of user activity, such as user logouts, in user activity 332, which is transmitted to resource demand tracker 402. Resource demand tracker 402 may provide the user logout indication to proactive decision maker 404 through tracker data 440. Proactive decision maker 404 may use the user activity data included in tracker data 440 to predict resource scaling needs of the user and determine a corresponding resource scaling decision (e.g., a decision to reclaim resources from the user, an indication of which resources to reclaim, etc.), which is indicated in scaling decision 412. Resource scaler 406 receives scaling decision 412, and based thereon, is configured to reclaim the indicated resources from the user. Resource scaler 406 may transmit resource scaling request 334, with the resource scaling instruction, to resource pool 320 to cause resource pool 320 to reclaim allocated resources 348. As indicated by resource reclamation 338, allocated resources 348 are reclaimed by resource pool 320. A data structure (e.g., a table, not shown in FIG. 3) within resource pool 320 may be updated by marking resources in resource pool 320 according to resource availability (e.g., allocated, unavailable, no longer allocated). Reclaiming resources from the user may be performed by updating the allocated user resources in the data structure as, for example, “unallocated”.

In step 704, a plurality of login patterns is determined for the user from historical data of user interactions with the database, each login pattern of the login patterns corresponding to a respective time window of a plurality of time windows having a same start of predicted activity. In an embodiment, proactive decision maker 404 determines, from historical data of user interactions with the database (i.e., historical user interaction data 342), a plurality of login patterns for the user. Historical interaction data 342 includes a history of interactions by the user with database 318, including a history (e.g., day and time) of logins and logouts of the user with database 318.

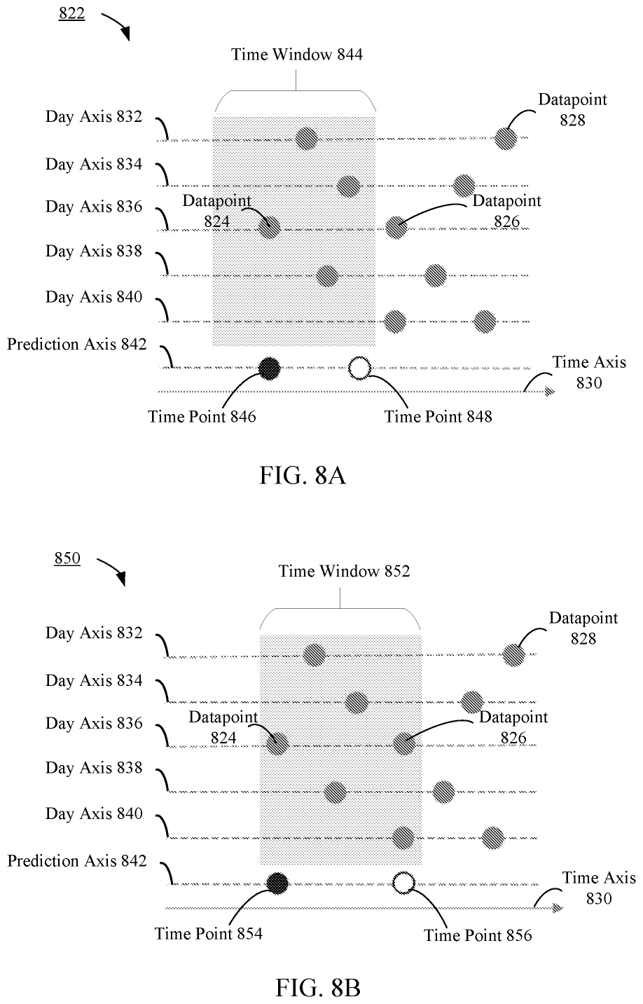

An example of historical user interaction data 342, is described further below in a timeline 822 and a timeline 850 of FIG. 8A and FIG. 8B, respectively, with associated datapoints that are indications of log in events for the user to database 318. Timeline 822 comprises a time window 844, a time point 846, and a time point 848. Timeline 850 comprises a time window 852, a time point 854, and a time point 856. Timelines 822 and 850 include shared elements, such as: a time axis 830, a datapoint 824, a datapoint 826, a datapoint 828, a day axis 832, a day axis 834, a day axis 836, a day axis 838, a day axis 840 (collectively referred to as day axes 832-840), and a prediction axis 842. In particular, timelines 822 and 850 show historical log in times for the user each day over the prior five days, which are represented as first-fifth day axes 832, 834, 836, 838, and 840, respectively. On day axis 832, representative of one day prior, the user logged in twice, including the latest login shown for all five days at datapoint 828. Day axis 836, representative of three days prior, shows two logins by the user, including the earliest login by the user of all five days.

Day axes 832-840 comprise historical user activity data (e.g., user login data) of the interactions of a user with a database. For example, day axes 832-840 may represent consecutive days that are plotted against time axis 830, and more particularly, against first-fifth day axes 832, 834, 836, 838, and 840, which represent five prior days of historical data of login events. Each day axes may include historical login data of a user for a specified day. Datapoints 824, 826, and 828 depict example datapoints of day axis 836 (e.g., datapoints 824 and 826) and day axis 832 (e.g., datapoint 828) in which a user logged into a database. Datapoint 828 is an example of a user logged into a database near the end of the day (i.e., towards the right of time axis 830) and datapoint 824 is an example of a user logged into a database near the beginning of the day (i.e., towards the left of time axis 830). Time point 846 and time point 854 are separate predictions of a start of activity between the user and the database, plotted against prediction axis 842. Time point 848 and time point 856 are separate predictions of an end of activity between the user and the database, plotted against prediction axis 842.

Note that although FIGS. 8A and 8B provide historical data of log in events for the prior five days, the historical data may cover any suitable predetermined historical time period, such as the previous 14 days, 28 days, 3 months, or any other suitable historical time period. The numbers and times of log ins by the user each day, as indicated in the retrieved historical data of historical user interaction data 342, are included in the determined login pattern for each day. As such, login patterns are determined for the user based on the historical data of historical user interaction data 342 for the number of prior days contained in historical user interaction data 342.

In an embodiment, proactive decision maker 404 determines the login patterns for time windows in the historical data. For example, to determine the login patterns, proactive decision maker 404 may collect historical login pattern data, including the times of past logins, for a series of time windows of predefined width (e.g., one hour) sequenced over a zone of time, such as a day. In an embodiment, proactive decision maker 404 may implement a sliding algorithm, as further described elsewhere, to collect login data over a sequence of time windows of predetermined width (e.g., a half hour, an hour, two hours, a half day, etc.), based on a comparison of the collected login data for the time windows, predict a next login time for the user.

For instance, following the determined user logout (of step 702 in FIG. 7), proactive decision maker 404 may collect login data for each instance of a sliding time window of a predetermined width that is slid along time axis 830 in increments of a predetermined time increment (e.g., 5 minutes). The first time window may immediately follow the time of user logout, and the time windows may be slid until day end is reached (midnight, 12:00 am), for 24 hours, or until another time milestone is reached. For each time window, the number of logins for the user that occurred during the time window over the covered historical time period (e.g., past month) are counted as the determined the login pattern for the window.

For instance, with reference to FIGS. 8A and 8B, first and second time windows 844 and 852 are shown. In this example, time windows 844 and 852 may have a width of one hour, the time increment of sliding may be 5 minutes, and the covered historical time period is 5 days. Following this example, proactive decision maker 404 would determine for first time window 844 that four logins occurred over the past five days, and for second time window 852 that six logins occurred over the past five days. Note that in other embodiments, proactive decision maker 404 may determine login patterns in another manner.

Note that in one embodiment, proactive decision maker 404 may determine login patterns for all possible time windows within the covered historical time period. In another embodiment, proactive decision maker 404 may determine login patterns for time windows having a same first start of predicted activity. In such an embodiment, proactive decision maker 404 may slide time windows until a time window is reached that includes a historical user login, which forms the login pattern for the time window, and also is designated as the first historical login. Proactive decision maker 404 then continues to slide the time window and determine corresponding login patterns until the first historical login is no longer present in a time window (i.e., the time window slid past the time of the login). In such case, may pause sliding windows and generating login patterns, having already generated login patterns for all the time windows containing the first historical login.

For instance, with respect to FIGS. 8A and 8B, both of time windows 844 and 852 encompass the earliest login, which occurred three days prior as represented by time axis 836. Thus, time windows 844 and 852, as well as possibly further time windows reached by the sliding window algorithm, have a same first day of predicted activity (where predicted activity may be a login time occurring on a past day that may be predicted to occur again on a present/future day). Login patterns are determined for all of the time windows determined to have the same first day of predicted activity before processing later time windows.

With reference again to flowchart 700 of FIG. 7, in step 706, a plurality of probabilities is calculated corresponding to the determined login patterns for the time windows, each calculated probability indicative of a likelihood that the user will log into the database during the corresponding time window of the time windows. In an embodiment, proactive decision maker 404 may be configured to calculate probabilities indicative of likelihoods the user will log into the database during corresponding time windows based on the corresponding determined login patterns. Proactive decision maker 404 may be configured to calculate the probabilities in any suitable manner, based on the determined login patterns. In one embodiment, proactive decision maker 404 may use an equation or algorithm to calculate the probabilities. In another embodiment, proactive decision maker 404 may utilize a machine learning model (i.e., ML model 346) to calculate the probabilities.

In step 708, in response to a set of the calculated probabilities being determined to have a predetermined relationship with a confidence threshold, the probability having a greatest likelihood is selected from the set. In an embodiment, all of the probabilities calculated for the login pattern-time window pairs are compared by proactive decision maker 404 to a confidence threshold. The confidence threshold is a predetermined value which can be assigned according to the level of confidence desired. If the confidence threshold is exceeded by a calculated probability, this indicates the corresponding time window is a valid candidate for determining predicted activity for the user. If the confidence threshold is not met by a calculated probability, this indicates the corresponding time window is insufficient for consideration of predicted activity for the user. A set of calculated probabilities (having the first start of predicted activity) determined by proactive decision maker 404 to exceed the confidence threshold may include one or more of the calculated probabilities, including all of the calculated probabilities, though in some cases, no calculated probability may be determined to exceed the confidence probability (as described in further detail below).

Furthermore, when a non-empty set is formed of calculated probabilities determined to exceed the confidence threshold, the greatest probability value is selected by proactive decision maker 404. For instance, continuing the example of FIGS. 8A and 8B, the confidence threshold may be 0.6. In such case, both of time windows 844 and 852 may be included in the determined set of calculated probabilities exceeding the confidence threshold. And because time window 852 has a greater calculated probability (1.0) than the calculated probability for time window 844 (0.8), calculated probability 1.0 for time window 852 is selected as having the greatest probability of the set.

In an instance in which the highest calculated probability is determined for more than one time window (i.e., a set of probabilities having the same highest calculated value), proactive decision maker 404 may select a particular probability based on a time associated with the corresponding time window of particular probability. For example, it is possible for two time windows (a first window and a second window) to have a calculated probability of 0.7, determined by proactive decision maker 404 as the highest probability calculated from a plurality of time windows. If the first window includes an earliest start time before the earliest start time of the second window, as determined by proactive decision maker 404, proactive decision maker 404 may select the first time window. In another embodiment, if the first window includes a predicted start of activity that is earlier than the second window, as determined by proactive decision maker 404, proactive decision maker 404 may select the first time window.

With reference again to flowchart 700 of FIG. 7, in step 710, the resources are reallocated to the user at a time associated with the time window corresponding to the selected probability. For example, proactive decision maker 404 may allocate, or initiate reallocation of, resources to the user at a time associated with the time window corresponding to the selected probability. Proactive decision maker 404 generates scaling decision 412 to cause resource pool 320 to reallocate resources to the user at a specified time. The data structure indicating the allocated resources for the user may then be updated, as described elsewhere herein. As described above, if proactive decision maker 404 determines the selected time window contains predicted activity (e.g., a login event during the time window in the historical data), proactive decision maker 404 may reallocate the resources to the user, based on a prediction that the user will login at a time within the selected time window.

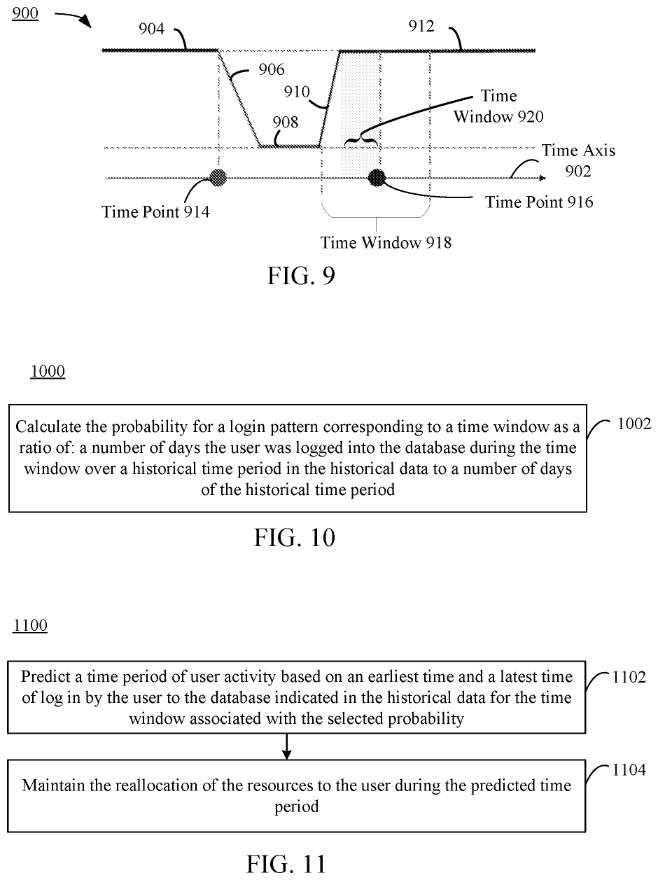

In an embodiment, the time associated with the selected time window (i.e., the time window associated with the selected probability) is a predetermined amount of time prior to the start of predicted activity in the selected time window, as further described with respect to FIG. 9 as follows. In particular, FIG. 9 shows a timeline 900 representative of a proactive resume approach for resource allocation of a user logging in and out of a database. Timeline 900 includes a time axis 902, a time segment 904, a time segment 906, a time segment 908, a time segment 910, a time segment 912, a time point 914, a time point 916, a time window 918, and a time window 920. Time axis 902 represents times over which login data for the user was extracted for timeline 900. Timeline 900 is further described as follows.

Timeline 900 begins at earliest time segment 904, during which a user is logged into the database and the database is resumed for the user who already has allocated resources. At time point 914, the user logs out of the database (i.e., workflow pauses) and during time segment 906, the database pauses and resources are reclaimed from the user. Time segment 906 represents the delay of the database between time segment 904, during which resources are allocated to the user, and time segment 908 (following time segment 906), during which resources are not available to the user. During time segment 904 and/or time segment 912, a prediction may be determined that during a future time window, the user will relog into the database. Time window 918 represents such a future time window, and in FIG. 9, includes time segment 910 and an initial portion of time segment 912. The prediction may be based upon a history of user interactions with the database, as further described elsewhere herein.

In the example of FIG. 9, the database resumes and reallocates resources to the user at the beginning of time window 918, to prepare for the user to log back in, per the prediction. Time segment 910 (a first portion of time window 918) represents the delay of the database between time segment 908, during which resources are not available to the user, and time segment 912 (after time segment 910), during which resources are allocated to the user. During time segment 912, the database resumes again and reallocates resources to the user. It is noted that the reallocated resources may remain unused by the user during time window 920, the time in which time segment 912 begins to time point 916 in which the user relogs into the database. A proactive resume approach, as visually represented in FIG. 9, may increase COGS for a provider of the database by idling resources, but may increase QoS due to the database preparing resources in advance for the user.

In an embodiment, proactive decision maker 404 may determine the probabilities according to FIG. 10, as described further below and with reference to step 706 of flowchart 700 in FIG. 7. FIG. 10 shows a flowchart 1000 for calculating a login probability for a time window, in accordance with an embodiment. Flowchart 1000 may be performed subsequent to flowchart 700 of FIG. 7. Other structural and operational embodiments will be apparent to persons skilled in the relevant art(s) based on the following discussion regarding flowchart 1000.

Flowchart 1000 begins with step 1002. In step 1002, the probability is calculated for a login pattern corresponding to a time window as a ratio of: a number of days the user was logged into the database during the time window over a historical time period in the historical data to a number of days of the historical time period. In an embodiment, proactive decision maker 404 may calculate a probability for each login pattern-time window pair according to the following Equation (5):

$$Probability = number of login days during time window / total number of days \qquad ( 5 )$$

Proactive decision maker 404 may be configured to calculate the probability for each login pattern-time window pair according to Equation (5).

For instance, continuing the example of FIGS. 8A and 8B, during time window 844 of FIG. 8A, the user logged into the database on each of day axes 832, 834, 836, and 838 (which each correspond to a day), for a total of four login days. Thus, proactive decision maker 404 may calculate the probability for time window 844 of FIG. 8A to be:

$$4 login days \div 5 total days = 0.8$$

Furthermore, during time window 852 of FIG. 8B, the user logged into the database on each of day axes 832, 834, 836 (twice), 838, and 840, for a total of five days. Thus, proactive decision maker 404 may calculate the probability for time window 852 to be:

$$5 login days \div 5 total days = 1.$$

In other embodiments, proactive decision maker 404 may be configured to calculate the probabilities in other ways.

As described below, in step 710 of flowchart 700, the resources are reallocated to the user at a time associated with the time window corresponding to the selected probability. Step 710 may be performed in various ways, in embodiments. For instance, in embodiments, proactive decision maker 404 may be configured to reallocate the resources to the user a predicted time associated with the selected time window, or over a range of times associated with the selected time window. For example, FIG. 11 shows a flowchart 1100 of a process for determining a time period for maintaining the reallocation of resources, in accordance with an embodiment. Flowchart 1100 may be performed subsequent to flowchart 700 of FIG. 7. In an embodiment, flowchart 1100 may be performed by proactive resource allocator 314. Other structural and operational embodiments will be apparent to persons skilled in the relevant art(s) based on the following discussion regarding flowchart 1100, which is provided with respect to FIGS. 3 and 4 for illustrative purposes.

Flowchart 1100 begins with step 1102. In step 1102, a time period of user activity is predicted based on an earliest time and a latest time of log in by the user to the database indicated in the historical data for the time window associated with the selected probability. In an embodiment, proactive decision maker 404 is configured to determine a time period for maintaining the allocation of the resources to the user based on an earliest time and a latest time of log in by the user in the selected time window, as indicated in the historical data. For instance, based on historical user interaction data 342, proactive decision maker 404 may determine the earliest and latest logins for the user in the selected window. Continuing the example of FIGS. 8A and 8B, proactive decision maker 404 may determine that for selected time window 852, the earliest and latest logins for the user occurred at the times of datapoints 824 and 826, respectively. As such, a time period of user activity may be predicted to be the time period between datapoints 824 and 826. Time points 854 and 856 on prediction axis 842, which correspond to datapoints 824 and 826, respectively represent the predicted earliest and latest time points of user activity and encompass the predicted time period of user activity as the time period between them.

In step 1104, the reallocation of the resources to the user is maintained during the predicted time period. As described above with respect to step 710 of flowchart 700, proactive decision maker 404 may reallocate the resources to the user. In an embodiment, proactive decision maker 404 may maintain the reallocation of the resources across the time period predicted in step 1102 based on the first and last times of login of the user in the selected window (e.g., between datapoints 824 and 826 in the example of FIG. 8B).

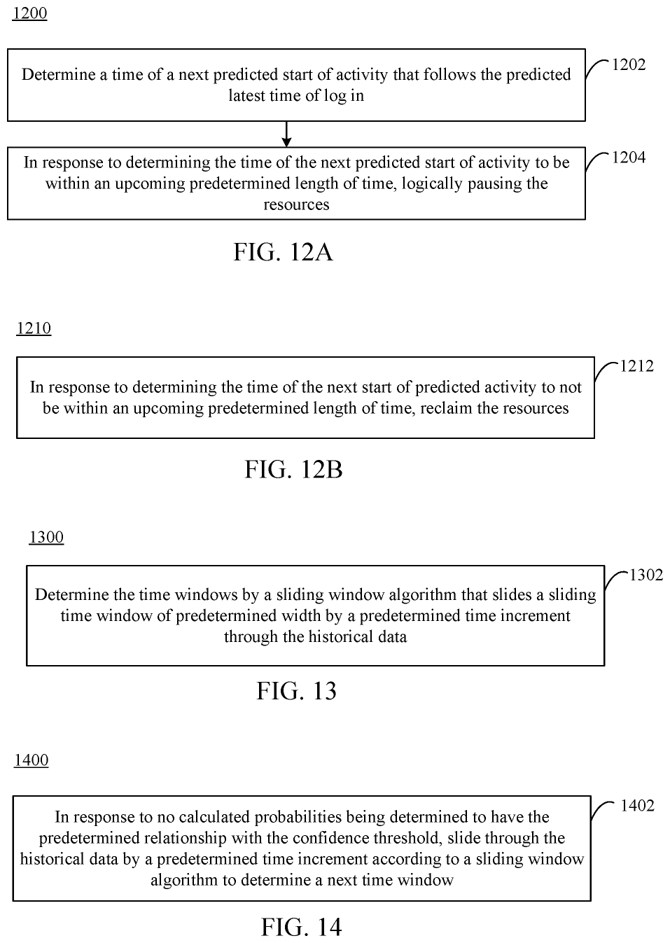

FIGS. 12A and 12B depict further aspects of proactive resume. For instance, subsequent to flowchart 700, a future time of activity may be predicted, and action may be taken with regard to the resources based on the predicted future time, including the logical or physical pause of the resources. For example, FIG. 12A shows a flowchart 1200 of a process for pausing resources with respect to a next predicted start of activity, in accordance with an embodiment. Flowchart 1200 may be performed by resource demand tracker 402 and proactive resource allocator 314, may be implemented in systems 300 and 600, and may be performed subsequent to flowchart 1100 of FIG. 11, in embodiments. For purposes of illustration, flowchart 1200 is described with reference to FIGS. 3-5. Other structural and operational embodiments will be apparent to persons skilled in the relevant art(s) based on the following discussion regarding flowchart 1200.

In step 1202, a time of a next predicted start of activity that follows the predicted latest time of log in is determined. In an embodiment, the time of the next predicted start of activity may be determined by repeating the steps of flowchart 700 (i.e., steps 702, 704, 706, 708, and/or 710). For instance, proactive decision maker 404 may perform the determination for the time of the next predicted start of activity according to a sliding window algorithm. The sliding window algorithm may slide through the historical user data by a predetermined time increment to determine one or more next time windows, calculate corresponding probabilities, determine a calculated probability to have a predetermined relationship with a confidence threshold to be the greatest probability, and determine the next predicted start of activity for the corresponding time window.

In step 1204, in response to determining the time of the next predicted start of activity to be within an upcoming predetermined length of time, the resources are logically paused. In embodiment, proactive decision maker 404 may determine the determined time of next precited start of activity to be relatively near in time (i.e., within the upcoming predetermined length of time, such as 7 hours). In such case, proactive decision maker 404 may logically pause the resources allocated to the user so that the resources are still available to the user but the user is not charged for them.

Alternatively, proactive decision maker 404 may determine the determined time of next predicted start of activity to be relatively far away in time (i.e., not within the upcoming predetermined length of time). In such case, proactive decision maker 404 may reclaim the resources. For instance, FIG. 12B shows a flowchart 1210 of a process for reclaiming resources upon expiration of the predetermined length of time, in accordance with an embodiment. FIG. 12B depicts an alternative to step 1204 of FIG. 12A. For purposes of illustration, flowchart 1210 is described with reference to FIGS. 3-5. Other structural and operational embodiments will be apparent to persons skilled in the relevant art(s) based on the following discussion regarding flowchart 1210.

Flowchart 1210 begins with step 1212. In step 1212, the resources are reclaimed in response to determining the time of the next start of predicted activity to not be within an upcoming predetermined length of time. In an embodiment, proactive decision maker 404 determines whether the next start of predicted activity is relatively near in time (e.g., within a predetermined length of time, such as 5 hours, 7 hours, 12 hours, etc.). If the predicted activity is near in time, it may be considered more efficient to maintain the resources allocated to the user. Otherwise, it may be considered more efficient to reclaim the resources, as in step 1212.

As such, according to flowcharts 12A and 12B, proactive decision maker 404 may generate scaling decision 412 to logically pause or reclaim resources allocated to the user for a proactive resume policy. For example, the current time may be 12:00 PM and the upcoming predetermined length of time may be 7 hours. Thus, the determined next start time of predicted activity needs to be in the upcoming timeframe, 12:00 PM-7:00 PM, in order for the resources to be logically paused. If the time of the next time window is determined to be 3:00 PM, for example, the resources are logically paused (i.e., allocated to the user despite the user being logged out) by proactive decision maker 404. However, if the time of the next time window is determined to be 8:00 PM, for example, the resources are reclaimed by proactive decision maker 404.

Step 1204 of FIG. 12A may be depicted, in part, by transition 604 of FIG. 6. At transition 604, the next predicted resume time of the user is determined by proactive decision maker 404 as either soon or unknown (e.g., by Algorithm 1). As a result, proactive decision maker 404 makes scaling decision 412 to logically pause allocated resources 348, which transitions from the resumed state to the logically paused state. Furthermore, step 1212 of FIG. 12B may be depicted, in part, by transition 604 of FIG. 6. At transition 614, the user is determined as idle by resource demand tracker 402, allocated resources 348 are in the resumed state, and proactive decision maker 404 may predict the next resume time is far off. In this case, allocated resources 348 transitions from the resumed state to the physically paused state.

Note that proactive decision maker 404 may be further configured to send indications of successful and unsuccessful determinations of next start of predicted user activity to long-term history store 506 in backend 308 as user interaction data 344. Backend 308 may process the received indications as further described elsewhere herein.

As described elsewhere herein, a sliding window algorithm may be used for implementing proactive resume or proactive pause. For instance, FIG. 13 shows a flowchart 1300 for utilizing a sliding window algorithm in a probabilistic resume process, in accordance with an embodiment. Flowchart 1300 may be performed by proactive decision maker 404, may be implemented in systems 300 and 600, and may be performed in step 704 of flowchart 700 of FIG. 7, and subsequent to flowchart 700, in embodiments. For purposes of illustration, flowchart 1300 is described with reference to FIGS. 3-5. Other structural and operational embodiments will be apparent to persons skilled in the relevant art(s) based on the following discussion regarding flowchart 1300.

In step 1302 of flowchart 1300, the time windows are determined by a sliding window algorithm that slides a sliding time window of predetermined width by a predetermined time increment through the historical data. In an embodiment, proactive decision maker 404 may include a sliding window algorithm to determine the time windows for which the login patterns of step 704 are determined, as well as to determine further time windows subsequent to flowchart 700. For instance, in the event that no probabilities are determined to have the predetermined relationship with the confidence threshold for the current sequence of time window that have a same first start of predicted activity, proactive decision maker 404 may continue to determine new time windows in the historical data (that have a same first start of predicted activity), and reperform steps 704-708 of flowchart 700 based on the new windows. In this manner, proactive decision maker 404 continues to work forward in time through the historical data to determine a time of predicted activity at which time a decision can be made whether to resume the resources assigned to the user.

An example of sliding time windows designated according to a sliding window algorithm is depicted in FIGS. 8A and 8B, respectively showing timeline 822 and timeline 850 that may represent a sliding window algorithm for five days of historical user activity of a database, in accordance with embodiments. Sliding window algorithms utilize a range (i.e., window size) of data in a dataset to move (i.e., slides) through windows of the dataset. At each window increment or decrement, a computation or determination may be performed by the algorithm to analyze or extract information from the dataset. A sliding window algorithm may be incorporated into a probabilistic or predictive algorithm, such as Algorithm 1, in an embodiment, for time windows 844 and 852 of timelines 822 and 850 respectively. Time windows 844 and 852 are consecutive time periods that may be determined by a sliding window algorithm and used to determine the time windows of step 704, for which login patterns are determined.

A sliding window algorithm may operate according to time window 844 and time window 852 in example embodiments. Time window 844 is a window of time of which the start time and end time may be predetermined according to a window size of the algorithm. Time point 846 and time point 854 may be computed on prediction axis 842, within time window 844 and time window 852, respectively, based on the datapoints within each time window, where each datapoint corresponds to a historical login by the user. For example, time point 846 may be the same time as datapoint 824, based on an earliest datapoint in time window 844, and time point 854 may also be the same time as datapoint 824, based on an earliest datapoint in time window 852. Time point 848 may be the same time as a datapoint in time window 844, based on an latest datapoint, and time point 856 may be the same time as a datapoint in time window 852, based on a latest datapoint in time window 852. Time window 844 comprises 4 datapoints (one in each of day axis 832, 834, 836, and 838) over the span of all 5 day axes 832-840. Four out of five days include datapoints within time window 844. Thus, a probability of the user logging into the database for a day in the future between the start time and end time of time window 844 may be computed as 4/5=0.8. Time window 852 comprises 6 datapoints (one in each of day axis 832, 834, 838, and 840 and two in day axis 836) over the span of all 5 day axes 832-840. Five out of five days include datapoints within time window 852. Thus, a probability of the user logging into the database for a day in the future between the start time and end time of time window 852 may be computed as 5/5=1.

The sliding window algorithm may be used to enable proactive pause and resume decisions based on calculated probabilities corresponding to multiple windows of a dataset. For instance, because time window 852 has a higher computed probability than time window 844, the sliding window algorithm may predict that the user will log into the database in the future between the start time and end time of time window 852. In an embodiment, the sliding window algorithm may have more than two windows in which to compute probabilities. In a further embodiment, in the event of two computed probabilities matching, the algorithm may make a prediction based on a time precedence. For instance, the start time and end time of a time window with the earliest start time (when compared to all time windows) may be selected for the decision.

As described above with respect to step 708 of flowchart 700, a set of the calculated probabilities is determined to have a predetermined relationship with a confidence threshold. FIG. 14 relates to the alternative, where no probabilities are determined to have the predetermined relationship with the confidence threshold. In particular, FIG. 14 shows a flowchart 1400 for stepping through additional time windows to find user activity, in accordance with an embodiment. In an embodiment, flowchart 1400 may be performed by proactive resource allocator 314 of FIGS. 3 and 4 and may be performed as a continuation of flowchart 700 of FIG. 7. Other structural and operational embodiments will be apparent to persons skilled in the relevant art(s) based on the following discussion regarding flowchart 1400, which is provided with respect to FIGS. 3 and 4 for illustrative purposes.

Flowchart 1400 begins with step 1402. In step 1402, in response to no calculated probabilities being determined to have the predetermined relationship with the confidence threshold, a next time window is determined by sliding through the historical data by a predetermined time increment according to a sliding window algorithm. In an embodiment, as described above, a sliding window algorithm may be used to step through the historical data in search of user activity used to make a decision whether to resume or pause user resources. In the event that no probabilities are determined to have the predetermined relationship with the confidence threshold for the current sequence of time window that have a same first start of predicted activity, proactive decision maker 404 may continue to determine new time windows in the historical data (that have a same first start of predicted activity), and reperform steps 704-708 of flowchart 700 based on the new windows. In this manner, proactive decision maker 404 continues to work forward in time through the historical data to determine a time of predicted activity at which time a decision can be made whether to resume or pause the resources assigned to the user.

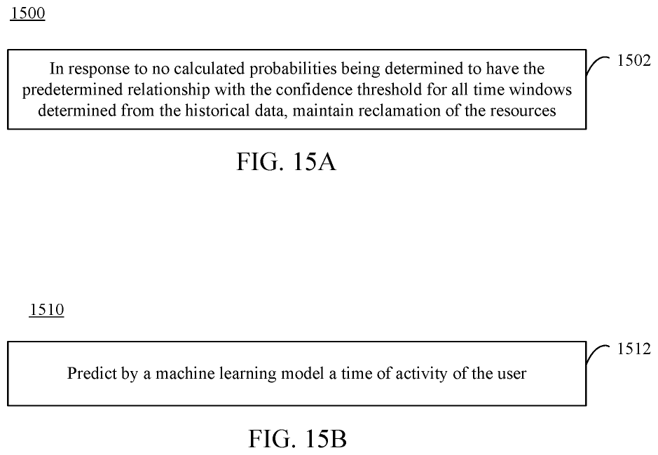

It is noted that that the entirety of a predetermined historical time period (e.g., a month) may be analyzed in the historical data, with no time window being found that satisfies the confidence threshold of step 708. In such case, a determination may be made whether/how to pause the resources. In particular, FIG. 15A shows a flowchart 1500 for handling allocated resources when sufficient user activity to warrant resume is not found, in accordance with an embodiment. In an embodiment, flowchart 1500 may be performed by proactive resource allocator 314 of FIGS. 3 and 4 and may be a continuation of flowchart 700 of FIG. 7. Other structural and operational embodiments will be apparent to persons skilled in the relevant art(s) based on the following discussion regarding flowchart 1500, which is provided with respect to FIGS. 3 and 4 for illustrative purposes.

FIG. 15A relates to an alternative of FIG. 7, where no probabilities are determined to have the predetermined relationship with the confidence threshold. Flowchart 1500 begins with step 1502. In particular, in step 1502, in response to no calculated probabilities being determined to have the predetermined relationship with the confidence threshold for all time windows determined from the historical data, the resources are maintained as reclaimed (the resources are not reallocated to the user). In an embodiment, when no probabilities satisfy the confidence threshold, proactive decision maker 404 may decide to maintain reclamation of the resources from the user rather than reallocate the resources to the user. This is due to the calculated probabilities not having a high enough confidence of the user logging back into the database, and thus the decision to maintain reclamation of the resources is made.

As described further above, a machine learning (ML) model may be used to perform aspects of proactive resume and proactive pause, including being able to effectively perform steps 704 and 706 of flowchart 700 (FIG. 7) by predicting the activity pattern per database and by pausing/resuming the resources based on this prediction. Furthermore, an ML model may additionally compute confidence of prediction and filter by confidence, thereby additionally performing step 708 of flowchart 700, in an embodiment. Such ML models may operate in various ways.

For instance, FIG. 15B shows a flowchart 1510 for utilizing a machine learning model for proactive resource allocation, in accordance with embodiments. In an embodiment, flowchart 1510 may be performed by proactive resource allocator 314, may be implemented in systems 300 and 600, and may be performed subsequent to flowchart 700 of FIG. 7. For purposes of illustration, flowchart 1510 is described with reference to FIGS. 3-5. Other structural and operational embodiments will be apparent to persons skilled in the relevant art(s) based on the following discussion regarding flowchart 1510.

Flowchart 1510 begins with step 1512. In step 1512, a time of activity of the user is predicted by a machine learning model. As described in further detail elsewhere herein, model trainer 502 may be configured to train ML model 346 based on input data (input features) of historical data of one or both of long-term history store 506 and/or history store 306. Trained ML model 346 may be implemented by proactive decision maker 404 to make predictions of user activity following user logout, and thus may be implemented as a replacement for steps 704 and 706 in flowchart 700. For example, ML model 346 may receive a log out time of the user as input, and based on that input, generate a predicted time when the user may log back in. Furthermore, in an embodiment, ML model 346 may be trained to compute confidence of prediction and filter by confidence, and thus further replace step 708 of flowchart 700.

### III. Example Computing Device Embodiments

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including implementation as computer program code configured to be executed in one or more processors and stored in a computer readable storage medium, or implementation as hardware logic/electrical circuitry, such as implementation together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

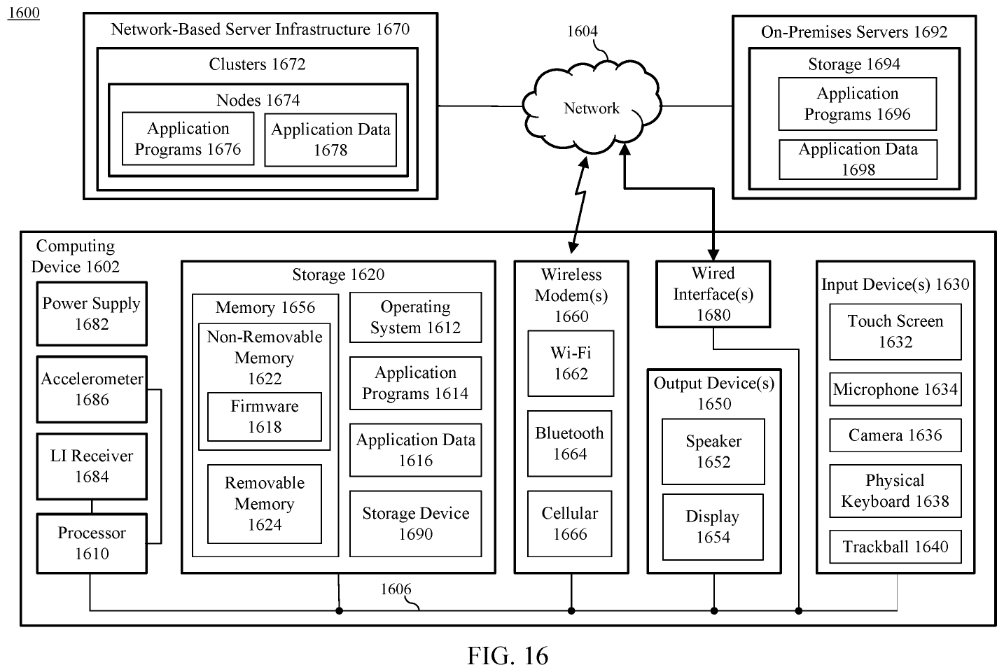

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 16. FIG. 16 shows a block diagram of an exemplary computing environment 1600 that includes a computing device 1602.

Computing devices 302A-302N, database management server system 310, database 318, history store 306, backend 308, and resource manager 312 may each include one or more of the components of computing device 1602. In some embodiments, computing device 1602 is communicatively coupled with devices (not shown in FIG. 16) external to computing environment 1600 via network 1604. Network 1604 is an example of network 304 of FIG. 3. Network 1604 comprises one or more networks such as local area networks (LANs), wide area networks (WANs), enterprise networks, the Internet, etc., and may include one or more wired and/or wireless portions. Network 1604 may additionally or alternatively include a cellular network for cellular communications. Computing device 1602 is described in detail as follows.

Computing device 1602 can be any of a variety of types of computing devices. For example, computing device 1602 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 1602 may alternatively be a stationary computing device such as a desktop computer, a personal computer (PC), a stationary server device, a minicomputer, a mainframe, a supercomputer, etc.

As shown in FIG. 16, computing device 1602 includes a variety of hardware and software components, including a processor 1610, a storage 1620, one or more input devices 1630, one or more output devices 1650, one or more wireless modems 1660, one or more wired interfaces 1680, a power supply 1682, a location information (LI) receiver 1684, and an accelerometer 1686. Storage 1620 includes memory 1656, which includes non-removable memory 1622 and removable memory 1624, and a storage device 1690. Storage 1620 also stores an operating system 1615, application programs 1614, and application data 1616. Wireless modem(s) 1660 include a Wi-Fi modem 1662, a Bluetooth modem 1664, and a cellular modem 1666. Output device(s) 1650 includes a speaker 1652 and a display 1654. Input device(s) 1630 includes a touch screen 1632, a microphone 1634, a camera 1636, a physical keyboard 1638, and a trackball 1640. Not all components of computing device 1602 shown in FIG. 16 are present in all embodiments, additional components not shown may be present, and any combination of the components may be present in a particular embodiment. These components of computing device 1602 are described as follows.

A single processor 1610 (e.g., central processing unit (CPU), microcontroller, a microprocessor, signal processor, ASIC (application specific integrated circuit), and/or other physical hardware processor circuit) or multiple processors 1610 may be present in computing device 1602 for performing such tasks as program execution, signal coding, data processing, input/output processing, power control, and/or other functions. Processor 1610 may be a single-core or multi-core processor, and each processor core may be single-threaded or multithreaded (to provide multiple threads of execution concurrently). Processor 1610 is configured to execute program code stored in a computer readable medium, such as program code of operating system 1612 and application programs 1614 stored in storage 1620. Operating system 1612 controls the allocation and usage of the components of computing device 1602 and provides support for one or more application programs 1614 (also referred to as “applications” or “apps”). Application programs 1614 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 1602 can communicate with any other component according to function, although not all connections are shown for ease of illustration. For instance, as shown in FIG. 16, bus 1606 is a multiple signal line communication medium (e.g., conductive traces in silicon, metal traces along a motherboard, wires, etc.) that may be present to communicatively couple processor 1610 to various other components of computing device 1602, although in other embodiments, an alternative bus, further buses, and/or one or more individual signal lines may be present to communicatively couple components. Bus 1606 represents one or more of any of several types of bus structures, including a memory bus or memory controller, a peripheral bus, an accelerated graphics port, and a processor or local bus using any of a variety of bus architectures.

Storage 1620 is physical storage that includes one or both of memory 1656 and storage device 1690, which store operating system 1612, application programs 1614, and application data 1616 according to any distribution. Non-removable memory 1622 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 1622 may include main memory and may be separate from or fabricated in a same integrated circuit as processor 1610. As shown in FIG. 16, non-removable memory 1622 stores firmware 1618, which may be present to provide low-level control of hardware. Examples of firmware 1618 include BIOS (Basic Input/Output System, such as on personal computers) and boot firmware (e.g., on smart phones). Removable memory 1624 may be inserted into a receptacle of or otherwise coupled to computing device 1602 and can be removed by a user from computing device 1602. Removable memory 1624 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 1690 may be present that are internal and/or external to a housing of computing device 1602 and may or may not be removable. Examples of storage device 1690 include a hard disk drive, a SSD, a thumb drive (e.g., a USB (Universal Serial Bus) flash drive), or other physical storage device.

One or more programs may be stored in storage 1620. Such programs include operating system 1612, one or more application programs 1614, and other program modules and program data. Examples of such application programs may include, for example, computer program logic (e.g., computer program code/instructions) for implementing one or more of database management server system 310, backend 308, resource manager 312, proactive resource allocator 314, query processor 316, database 318, allocated resources 348, resource demand tracker 402, proactive decision maker 404, resource scaler 406, model trainer 502, dashboard 504, and metrics evaluator 508, along with any components and/or subcomponents thereof, as well as the flowcharts/flow diagrams (e.g., flowcharts 700, 1000, 1100, 1200, 1210, 1300, 1400, 1500 and/or 1510) described herein, including portions thereof, and/or further examples described herein.

Storage 1620 also stores data used and/or generated by operating system 1612 and application programs 1614 as application data 1616. Examples of application data 1616 include web pages, text, images, tables, sound files, video data, and other data, which may also be sent to and/or received from one or more network servers or other devices via one or more wired or wireless networks. Storage 1620 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 1602 through one or more input devices 1630 and may receive information from computing device 1602 through one or more output devices 1650. Input device(s) 1630 may include one or more of touch screen 1632, microphone 1634, camera 1636, physical keyboard 1638 and/or trackball 1640 and output device(s) 1650 may include one or more of speaker 1652 and display 1654. Each of input device(s) 1630 and output device(s) 1650 may be integral to computing device 1602 (e.g., built into a housing of computing device 1602) or external to computing device 1602 (e.g., communicatively coupled wired or wirelessly to computing device 1602 via wired interface(s) 1680 and/or wireless modem(s) 1660). Further input devices 1630 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1654 may display information, as well as operating as touch screen 1632 by receiving user commands and/or other information (e.g., by touch, finger gestures, virtual keyboard, etc.) as a user interface. Any number of each type of input device(s) 1630 and output device(s) 1650 may be present, including multiple microphones 1634, multiple cameras 1636, multiple speakers 1652, and/or multiple displays 1654.

One or more wireless modems 1660 can be coupled to antenna(s) (not shown) of computing device 1602 and can support two-way communications between processor 1610 and devices external to computing device 1602 through network 1604, as would be understood to persons skilled in the relevant art(s). Wireless modem 1660 is shown generically and can include a cellular modem 1666 for communicating with one or more cellular networks, such as a GSM network for data and voice communications within a single cellular network, between cellular networks, or between the mobile device and a public switched telephone network (PSTN). Wireless modem 1660 may also or alternatively include other radio-based modem types, such as a Bluetooth modem 1664 (also referred to as a “Bluetooth device”) and/or Wi-Fi 1662 modem (also referred to as an “wireless adaptor”). Wi-Fi modem 1662 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1664 is configured to communicate with another Bluetooth-capable device according to the Bluetooth short-range wireless technology standard(s) such as IEEE 802.15.1 and/or managed by the Bluetooth Special Interest Group (SIG).

Computing device 1602 can further include power supply 1682, LI receiver 1684, accelerometer 1686, and/or one or more wired interfaces 1680. Example wired interfaces 1680 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 1680 of computing device 1602 provide for wired connections between computing device 1602 and network 1604, or between computing device 1602 and one or more devices/peripherals when such devices/peripherals are external to computing device 1602 (e.g., a pointing device, display 1654, speaker 1652, camera 1636, physical keyboard 1638, etc.). Power supply 1682 is configured to supply power to each of the components of computing device 1602 and may receive power from a battery internal to computing device 1602, and/or from a power cord plugged into a power port of computing device 1602 (e.g., a USB port, an A/C power port). LI receiver 1684 may be used for location determination of computing device 1602 and may include a satellite navigation receiver such as a Global Positioning System (GPS) receiver or may include other type of location determiner configured to determine location of computing device 1602 based on received information (e.g., using cell tower triangulation, etc.). Accelerometer 1686 may be present to determine an orientation of computing device 1602.

Note that the illustrated components of computing device 1602 are not required or all-inclusive, and fewer or greater numbers of components may be present as would be recognized by one skilled in the art. For example, computing device 1602 may also include one or more of a gyroscope, barometer, proximity sensor, ambient light sensor, digital compass, etc. Processor 1610 and memory 1656 may be co-located in a same semiconductor device package, such as included together in an integrated circuit chip, FPGA, or system-on-chip (SOC), optionally along with further components of computing device 1602.

In embodiments, computing device 1602 is configured to implement any of the above-described features of flowcharts herein. Computer program logic for performing any of the operations, steps, and/or functions described herein may be stored in storage 1620 and executed by processor 1610.

In some embodiments, server infrastructure 1670 may be present in computing environment 1600 and may be communicatively coupled with computing device 1602 via network 1604. Server infrastructure 1670, when present, may be a network-accessible server set (e.g., a cloud-based environment or platform). As shown in FIG. 16, server infrastructure 1670 includes clusters 1672. Each of clusters 1672 may comprise a group of one or more compute nodes and/or a group of one or more storage nodes. For example, as shown in FIG. 16, cluster 1672 includes nodes 1674. Each of nodes 1674 are accessible via network 1604 (e.g., in a “cloud-based” embodiment) to build, deploy, and manage applications and services. Any of nodes 1674 may be a storage node that comprises a plurality of physical storage disks, SSDs, and/or other physical storage devices that are accessible via network 1604 and are configured to store data associated with the applications and services managed by nodes 1674. For example, as shown in FIG. 16, nodes 1674 may store application data 1678.

Each of nodes 1674 may, as a compute node, comprise one or more server computers, server systems, and/or computing devices. For instance, a node 1674 may include one or more of the components of computing device 1602 disclosed herein. Each of nodes 1674 may be configured to execute one or more software applications (or “applications”) and/or services and/or manage hardware resources (e.g., processors, memory, etc.), which may be utilized by users (e.g., customers) of the network-accessible server set. For example, as shown in FIG. 16, nodes 1674 may operate application programs 1676. In an implementation, a node of nodes 1674 may operate or comprise one or more virtual machines, with each virtual machine emulating a system architecture (e.g., an operating system), in an isolated manner, upon which applications such as application programs 1676 may be executed.

In an embodiment, one or more of clusters 1672 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 1672 may be a datacenter in a distributed collection of datacenters. In embodiments, exemplary computing environment 1600 comprises part of a cloud-based platform such as Amazon Web Services® of Amazon Web Services, Inc., or Google Cloud Platform™ of Google LLC, although these are only examples and are not intended to be limiting.

In an embodiment, computing device 1602 may access application programs 1676 for execution in any manner, such as by a client application and/or a browser at computing device 1602. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 1602 may additionally and/or alternatively synchronize copies of application programs 1614 and/or application data 1616 to be stored at network-based server infrastructure 1670 as application programs 1676 and/or application data 1678. For instance, operating system 1612 and/or application programs 1614 may include a file hosting service client, such as Microsoft® OneDrive® by Microsoft® Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 1620 at network-based server infrastructure 1670.

In some embodiments, on-premises servers 1692 may be present in computing environment 1600 and may be communicatively coupled with computing device 1602 via network 1604. On-premises servers 1692, when present, are hosted within the infrastructure of an organization and, in many cases, physically onsite of a facility of that organization. On-premises servers 1692 are controlled, administered, and maintained by IT (Information Technology) personnel of the organization or an IT partner to the organization. Application data 1698 may be shared by on-premises servers 1692 between computing devices of the organization, including computing device 1602 (when part of an organization) through a local network of the organization, and/or through further networks accessible to the organization (including the Internet). Furthermore, on-premises servers 1692 may serve applications such as application programs 1696 to the computing devices of the organization, including computing device 1602. Accordingly, on-premises servers 1692 may include storage 1694 (which includes one or more physical storage devices such as storage disks and/or SSDs) for storage of application programs 1696 and application data 1698 and may include one or more processors for execution of application programs 1696. Still further, computing device 1602 may be configured to synchronize copies of application programs 1614 and/or application data 1616 for backup storage at on-premises servers 1692 as application programs 1696 and/or application data 1698.

Embodiments described herein may be implemented in one or more of computing device 1602, network-based server infrastructure 1670, and on-premises servers 1692. For example, in some embodiments, computing device 1602 may be used to implement systems, clients, or devices, or components/subcomponents thereof, disclosed elsewhere herein. In other embodiments, a combination of computing device 1602, network-based server infrastructure 1670, and/or on-premises servers 1692 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1620. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 1614) may be stored in storage 1620. Such computer programs may also be received via wired interface(s) 1680 and/or wireless modem(s) 1660 over network 1604. Such computer programs, when executed or loaded by an application, enable computing device 1602 to implement features of embodiments discussed herein. Accordingly, such computer programs represent controllers of the computing device 1602.

Embodiments are also directed to computer program products comprising computer code or instructions stored on any computer-readable medium or computer-readable storage medium. Such computer program products include the physical storage of storage 1620 as well as further physical storage types.

### IV. Additional Example Embodiments

In one embodiment, a system is described herein, comprising: a processor; and a memory device that stores program code structured to cause the processor to: reclaim resources from a user in response to the user logging out of a database; determine a plurality of login patterns for the user from historical data of user interactions with the database, each login pattern of the login patterns corresponding to a respective time window of a plurality of time windows having a same start of predicted activity; calculate a plurality of probabilities corresponding to the determined login patterns for the time windows, each calculated probability indicative of a likelihood that the user will log into the database during the corresponding time window of the time windows; in response to a set of the calculated probabilities being determined to have a predetermined relationship with a confidence threshold, select from the set the probability having a greatest likelihood; and reallocate the resources to the user at a time associated with the time window corresponding to the selected probability.

In an embodiment of the system, wherein to calculate the plurality of probabilities, the program code is further structured to cause the processor to: calculate the probability for a login pattern corresponding to a time window as a ratio of: a number of days the user was logged into the database during the time window over a historical time period in the historical data; to a number of days of the historical time period.

In a further embodiment of the system, the time associated with the time window is at a predetermined amount of time prior to the start of predicted activity corresponding to the selected probability.

In a further embodiment of the system, the program code is further structured to cause the processor to: in response to no calculated probabilities being determined to have the predetermined relationship with the confidence threshold, slide through the historical data by a predetermined time increment according to a sliding window algorithm to determine a next time window.

In an embodiment of the aforementioned system, the program code is further structured to cause the processor to: predict a time period of user activity based on an earliest time and a latest time of log in by the user to the database indicated in the historical data for the time window associated with the selected probability; and maintain the reallocation of the resources to the user during the predicted time period.

In an embodiment of the aforementioned system, the program code is further structured to cause the processor to: determine a time of a next predicted start of activity that follows the predicted latest time of log in; in response to determining the time of the next predicted start of activity to be within an upcoming predetermined length of time, logically pause the resources; and in response to determining the time of the next predicted start of activity to not be within an upcoming predetermined length of time, reclaim the resources.

In a further embodiment of the system, the program code is further structured to cause the processor to: in response to no calculated probabilities being determined to have the predetermined relationship with the confidence threshold for all time windows determined from the historical data, maintain reclamation of the resources.

In one embodiment, a method is described herein, comprising: reclaiming resources from a user in response to the user logging out of a database; determining a plurality of login patterns for the user from historical data of user interactions with the database, each login pattern of the login patterns corresponding to a respective time window of a plurality of time windows having a same start of predicted activity; calculating a plurality of probabilities corresponding to the determined login patterns for the time windows, each calculated probability indicative of a likelihood that the user will log into the database during the corresponding time window of the time windows; in response to a set of the calculated probabilities being determined to have a predetermined relationship with a confidence threshold, selecting from the set the probability having a greatest likelihood; and reallocating the resources to the user at a time associated with the time window corresponding to the selected probability.

In an embodiment of the method, said calculating comprises: calculating the probability for a login pattern corresponding to a time window as a ratio of: a number of days the user was logged into the database during the time window over a historical time period in the historical data; to a number of days of the historical time period.

In a further embodiment of the method, the time associated with the time window is at a predetermined amount of time prior to the start of predicted activity corresponding to the selected probability.

In a further embodiment, the method further comprises: in response to no calculated probabilities being determined to have the predetermined relationship with the confidence threshold, sliding through the historical data by a predetermined time increment according to a sliding window algorithm to determine a next time window.

In an embodiment of the aforementioned method, the method further comprises: predicting a time period of user activity based on an earliest time and a latest time of log in by the user to the database indicated in the historical data for the time window associated with the selected probability; and maintaining the reallocation of the resources to the user during the predicted time period.

In a further embodiment of the aforementioned method, the method further comprises: determining a time of a next predicted start of activity that follows the predicted latest time of log in; in response to determining the time of the next predicted start of activity to be within an upcoming predetermined length of time, logically pausing the resources; and in response to determining the time of the next predicted start of activity to not be within an upcoming predetermined length of time, reclaiming the resources.

In a further embodiment, the method further comprises: in response to no calculated probabilities being determined to have the predetermined relationship with the confidence threshold for all time windows determined from the historical data, maintaining reclamation of the resources.

In one embodiment, a computer-readable storage device is described herein, encoded with program instructions that, when executed by a processor circuit, perform a method comprising: reclaiming resources from a user in response to the user logging out of a database; determining a plurality of login patterns for the user from historical data of user interactions with the database, each login pattern of the login patterns corresponding to a respective time window of a plurality of time windows having a same start of predicted activity; calculating a plurality of probabilities corresponding to the determined login patterns for the time windows, each calculated probability indicative of a likelihood that the user will log into the database during the corresponding time window of the time windows; in response to a set of the calculated probabilities being determined to have a predetermined relationship with a confidence threshold, selecting from the set the probability having a greatest likelihood; and reallocating the resources to the user at a time associated with the time window corresponding to the selected probability.

In an embodiment of the computer-readable storage device, said calculating comprises: calculating the probability for a login pattern corresponding to a time window as a ratio of: a number of days the user was logged into the database during the time window over a historical time period in the historical data; to a number of days of the historical time period.

In a further embodiment of the computer-readable storage device, the time associated with the time window is at a predetermined amount of time prior to the start of predicted activity corresponding to the selected probability.

In a further embodiment of the computer-readable storage device, the method further comprises: in response to no calculated probabilities being determined to have the predetermined relationship with the confidence threshold, sliding through the historical data by a predetermined time increment according to a sliding window algorithm to determine a next time window.

In a further embodiment of the computer-readable storage device, the method further comprises: predicting a time period of user activity based on an earliest time and a latest time of log in by the user to the database indicated in the historical data for the time window associated with the selected probability; and maintaining the reallocation of the resources to the user during the predicted time period.

In a further embodiment of the computer-readable storage device, the method further comprises: determining a time of a next predicted start of activity that follows the predicted latest time of log in; in response to determining the time of the next predicted start of activity to be within an upcoming predetermined length of time, logically pausing the resources; and in response to determining the time of the next predicted start of activity to not be within an upcoming predetermined length of time, reclaiming the resources.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect as a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Several types of impactful operations have been described herein; however, lists of impactful operations may include other operations, such as, but not limited to, accessing enablement operations, creating and/or activating new (or previously-used) user accounts, creating and/or activating new subscriptions, changing attributes of a user or user group, changing multi-factor authentication settings, modifying federation settings, changing data protection (e.g., encryption) settings, elevating the privileges of another user account (e.g., via an admin account), retriggering guest invitation e-mails, and/or other operations that impact the cloud-base system, an application associated with the cloud-based system, and/or a user (e.g., a user account) associated with the cloud-based system.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A system, comprising:
a processor; and
a memory device that stores program code structured to cause the processor to:
reclaim resources from a user in response to the user logging out of a database;
determine a plurality of login patterns for the user from historical data of user interactions with the database, each login pattern of the login patterns corresponding to a respective time window of a plurality of time windows having a same start of predicted activity;
calculate a plurality of probabilities corresponding to the determined login patterns for the time windows, each calculated probability indicative of a likelihood that the user will log into the database during the corresponding time window of the time windows;
in response to a set of the calculated probabilities being determined to have a predetermined relationship with a confidence threshold, select from the set the probability having a greatest likelihood; and
reallocate the resources to the user at a time associated with the time window corresponding to the selected probability.

2. The system of claim 1, wherein to calculate the plurality of probabilities, the program code is further structured to cause the processor to:
calculate the probability for a login pattern corresponding to a time window as a ratio of:
a number of days the user was logged into the database during the time window over a historical time period in the historical data; to
a number of days of the historical time period.

3. The system of claim 1, wherein the time associated with the time window is at a predetermined amount of time prior to the start of predicted activity corresponding to the selected probability.

4. The system of claim 1, the program code further structured to cause the processor to:
in response to no calculated probabilities being determined to have the predetermined relationship with the confidence threshold, slide through the historical data by a predetermined time increment according to a sliding window algorithm to determine a next time window.

5. The system of claim 1, the program code further structured to cause the processor to:
predict a time period of user activity based on an earliest time and a latest time of log in by the user to the database indicated in the historical data for the time window associated with the selected probability; and
maintain the reallocation of the resources to the user during the predicted time period.

6. The system of claim 5, the program code further structured to cause the processor to:
determine a time of a next predicted start of activity that follows the predicted latest time of log in;
in response to determining the time of the next predicted start of activity to be within an upcoming predetermined length of time, logically pause the resources; and
in response to determining the time of the next predicted start of activity to not be within an upcoming predetermined length of time, reclaim the resources.

7. The system of claim 1, the program code further structured to cause the processor to:
in response to no calculated probabilities being determined to have the predetermined relationship with the confidence threshold for all time windows determined from the historical data, maintain reclamation of the resources.

8. A method, comprising:
reclaiming resources from a user in response to the user logging out of a database;
determining a plurality of login patterns for the user from historical data of user interactions with the database, each login pattern of the login patterns corresponding to a respective time window of a plurality of time windows having a same start of predicted activity;
calculating a plurality of probabilities corresponding to the determined login patterns for the time windows, each calculated probability indicative of a likelihood that the user will log into the database during the corresponding time window of the time windows;
in response to a set of the calculated probabilities being determined to have a predetermined relationship with a confidence threshold, selecting from the set the probability having a greatest likelihood; and
reallocating the resources to the user at a time associated with the time window corresponding to the selected probability.

9. The method of claim 8, wherein said calculating comprises:
calculating the probability for a login pattern corresponding to a time window as a ratio of:
a number of days the user was logged into the database during the time window over a historical time period in the historical data; to
a number of days of the historical time period.

10. The method of claim 8, wherein the time associated with the time window is at a predetermined amount of time prior to the start of predicted activity corresponding to the selected probability.

11. The method of claim 8, further comprising:
in response to no calculated probabilities being determined to have the predetermined relationship with the confidence threshold, sliding through the historical data by a predetermined time increment according to a sliding window algorithm to determine a next time window.

12. The method of claim 8, further comprising:
predicting a time period of user activity based on an earliest time and a latest time of log in by the user to the database indicated in the historical data for the time window associated with the selected probability; and
maintaining the reallocation of the resources to the user during the predicted time period.

13. The method of claim 12, further comprising:
determining a time of a next predicted start of activity that follows the predicted latest time of log in;
in response to determining the time of the next predicted start of activity to be within an upcoming predetermined length of time, logically pausing the resources; and
in response to determining the time of the next predicted start of activity to not be within an upcoming predetermined length of time, reclaiming the resources.

14. The method of claim 8, further comprising:
in response to no calculated probabilities being determined to have the predetermined relationship with the confidence threshold for all time windows determined from the historical data, maintaining reclamation of the resources.

15. A computer-readable storage device encoded with program instructions that, when executed by a processor circuit, perform a method comprising:
reclaiming resources from a user in response to the user logging out of a database;
determining a plurality of login patterns for the user from historical data of user interactions with the database, each login pattern of the login patterns corresponding to a respective time window of a plurality of time windows having a same start of predicted activity;
calculating a plurality of probabilities corresponding to the determined login patterns for the time windows, each calculated probability indicative of a likelihood that the user will log into the database during the corresponding time window of the time windows;
in response to a set of the calculated probabilities being determined to have a predetermined relationship with a confidence threshold, selecting from the set the probability having a greatest likelihood; and
reallocating the resources to the user at a time associated with the time window corresponding to the selected probability.

16. The computer-readable storage device of claim 15, wherein said calculating comprises:
calculating the probability for a login pattern corresponding to a time window as a ratio of:
a number of days the user was logged into the database during the time window over a historical time period in the historical data; to
a number of days of the historical time period.

17. The computer-readable storage device of claim 15, wherein the time associated with the time window is at a predetermined amount of time prior to the start of predicted activity corresponding to the selected probability.

18. The computer-readable storage device of claim 15, the method further comprising:
in response to no calculated probabilities being determined to have the predetermined relationship with the confidence threshold, sliding through the historical data by a predetermined time increment according to a sliding window algorithm to determine a next time window.

19. The computer-readable storage device of claim 15, the method further comprising:
predicting a time period of user activity based on an earliest time and a latest time of log in by the user to the database indicated in the historical data for the time window associated with the selected probability; and
maintaining the reallocation of the resources to the user during the predicted time period.

20. The computer-readable storage device of claim 19, the method further comprising:
determining a time of a next predicted start of activity that follows the predicted latest time of log in;
in response to determining the time of the next predicted start of activity to be within an upcoming predetermined length of time, logically pausing the resources; and
in response to determining the time of the next predicted start of activity to not be within an upcoming predetermined length of time, reclaiming the resources.
